(19) United States
(12) Patent Application Publication
(10) Pub. No.: US 2014/0204978 A1
(43) Pub. Date: Jul. 24, 2014

(54) TELEMETRY MULTIPLE ACCESS PROTOCOL OF A BEACON

(71) Applicant: TIMES THREE WIRELESS INC., Calgary (CA)

(72) Inventors: Michael Hryciuk, Calgary (CA); Ned Benner, Cal gary (CA); Edward Robert Benner, Calgary (CA); Michel Fattouche, Calgary (CA); Andrew Borsodi, Calgary (CA); Saeed Khalesehosseini, Calgary (CA)

(73) Assignee: TIMES THREE WIRELESS INC., Calgary (CA)

(21) Appl. No.: 13/745,754

(22) Filed: Jan. 19, 2013

(51) Int. Cl. H04B 1/713

(52) U.S. Cl. CPC H04B 1/713
USPC 375/133

(57) ABSTRACT

Systems, methods and apparatus are provided through which in some implementations a here-i-am (HIA) transmission on a first RF channel, a registration (REG) transmission on a second RF channel and a short-and-instant telemetry messaging (SIM) transmission on a third RF channel is operable to exchange data between a network and beacons using a wireless communications channel that permits the beacons to access the network for identification of the beacons.

### FIELD

This disclosure relates generally to telemetry, and more particularly to wireless telemetry of mobile devices.

### BACKGROUND

Prior work in this area uses a single transmission of a longer duration that includes both the detection and identification of the beacon requiring a larger number of communications channels resulting in a higher network equipment cost and a higher network operating cost.

### BRIEF DESCRIPTION

The above-mentioned shortcomings, disadvantages and problems are addressed herein, which will be understood by reading and studying the following specification.

The subject matter of this disclosure reduces the quantity of equipment, the deployment cost of the equipment, and the operating cost of the equipment required to support a large number of beacons used for the transfer of data from the beacon to the network from the network to the beacon and location of the beacon by the network, allows the use of the network to capture market needs that are currently not being serviced due to the cost of competing services that exceeds the value of the service to the customer and allows the use of the network to capture market needs that are currently being serviced by more costly services.

In one aspect, a computer-accessible medium includes a first component of processor-executable instructions to cause a first transmission from a beacon on a first radio frequency channel, the first transmission providing detection of the beacon by a network base station receiver, and the computer-accessible medium also includes a second component of processor-executable instructions to cause a second transmission from the beacon on a second radio frequency channel, the second transmission identifying the beacon and including information that is necessary to grant network access by the network base station receiver to the beacon.

In another aspect, a method of a beacon includes transmitting a here-i-am (HIA) transmission on a first radio frequency channel, to notify a network base station receiver that the beacon is in range of the network base station receiver to access the network base station receiver, to alert to the network base station receiver as to a presence of the beacon and to notify to the network base station receiver of a second radio frequency channel to transmit a registration (REG) transmission, transmitting the REG transmission that is synchronized to the HIA transmission on the second radio frequency channel, the REG transmission that is synchronized to the HIA transmission including a serial number of the beacon and including information representative of timing and information representative of radio frequencies in a pseudo-random frequency hopping pattern, transmitting a short-and-instant telemetry messaging (SIM) transmission on the radio frequencies in the plurality of the pseudo-random frequency hopping patterns and in accordance with the timing, the SIM transmission including data.

In yet another aspect, a computer-accessible medium includes processor-executable instructions for wireless communication from a beacon to a network base station receiver, the processor-executable instructions being capable of directing a processor to transmit a here-i-am (HIA) transmission on a first radio frequency channel of 12 radio frequency channels, to transmit the REG transmission that is synchronized to the HIA transmission on a pseudo-random frequency hopping pattern and in reference to a timing of the pseudo-random frequency hopping pattern, and to transmit a short-and-instant telemetry messaging (SIM) transmission on a second radio frequency channel of the one of the plurality of the pseudo-random frequency hopping patterns and in accordance with the timing of the frequency hopping patterns. The SIM transmission includes data and the data includes application-specific such as remote meter reading, smart grid, intelligent traffic signs, automotive, road condition telemetry, vending machine reporting, road construction equipment reporting. The data does not including the serial number of the beacon and the data not include the information representative of the timing and information representative of the one of the plurality of the pseudo-random frequency hopping patterns, in which the 12 radio frequency channels and the 42 radio frequency channels are mutually exclusive and have no radio frequency channels in common between the 12 radio frequency channels and the 42 radio frequency channels. The HIA transmission includes an identification of a second radio frequency channel of 42 radio frequency channels the beacon to transmit a registration (REG) transmission from the beacon to the base station network receive. The HIA transmission is a short transmission that does not include the serial number of the beacon. The REG transmission that is synchronized to the HIA transmission includes the serial number of the beacon, the REG transmission that is synchronized to the HIA transmission also includes information representative of the one of the plurality of the pseudo-random frequency hopping patterns and the REG transmission that is synchronized to the HIA transmission further includes the information representative of the timing of the frequency hopping patterns.

In still another aspect, a computer-accessible medium includes a first component of processor-executable instructions to receive a first transmission from a beacon a first radio frequency channel, the first transmission providing detection by the network base station receiver of the beacon, and the computer-accessible medium also includes a second component of processor-executable instructions to receive a second transmission from the beacon on a second radio frequency channel, the second transmission identifying the beacon and including information that is necessary to grant network access by the network base station receiver to the beacon.

In a further aspect, a method of a network base station receiver including receiving a here-i-am (HIA) transmission on a first radio frequency channel, the HIA transmission providing notice that a beacon is in range of the network base station receiver to access the network base station receiver, as an alert to the network base station receiver as to a presence of the beacon and as notice to the network base station receiver of a second radio frequency channel to receive a registration (REG) transmission, the method also including receiving the REG transmission that is synchronized to the HIA transmission on the second radio frequency channel, the REG transmission that is synchronized to the HIA transmission including a serial number of the beacon and including information representative of timing and information representative of radio frequencies in a pseudo-random frequency hopping pattern, and the method further including receiving a short-and-instant telemetry messaging (SIM) transmission on the radio frequencies in the plurality of the pseudo-random frequency hopping patterns and in accordance with the timing, the SIM transmission also including data.

In yet a further aspect, a computer-accessible medium includes processor-executable instructions for wireless communication at a network base station receiver between the network base station receiver and a beacon, the processor-executable instructions capable of directing a processor to perform receiving a here-i-am (HIA) transmission on a first radio frequency channel of 12 radio frequency channels, receiving the REG transmission that is synchronized to the HIA transmission on the pseudo-random frequency hopping pattern and in reference to the timing of the pseudo-random frequency hopping pattern and receiving a short-and-instant telemetry messaging (SIM) transmission on a second radio frequency channel of the one of the plurality of the pseudo-random frequency hopping patterns and in accordance with the timing of the frequency hopping patterns, the SIM transmission including application-specific data such as remote meter reading, smart grid, intelligent traffic signs, automotive, road condition telemetry, vending machine reporting, road construction equipment reporting, the data not including the serial number of the network base station receiver and the data not including the information representative of the timing and information representative of the one of the plurality of the pseudo-random frequency hopping patterns. The HIA transmission is a short transmission that does not include a serial number of the network base station receiver and that does not include information representative of one of a pseudo-random frequency hopping pattern and does not include information representative of timing of the frequency hopping patterns. The HIA transmission includes notice that the network base station receiver is in range of the beacon, a representation of imminent access to the beacon, and identification of a second radio frequency channel of 42 radio frequency channels the network base station receiver to transmit a registration (REG) transmission from the network base station receiver to the beacon. The REG transmission that is synchronized to the HIA transmission includes the serial number of the network base station receiver, including the information representative of the one of the plurality of the pseudo-random frequency hopping patterns and including the information representative of the timing of the frequency hopping patterns. The 12 radio frequency channels and the 42 radio frequency channels are mutually exclusive and have no radio frequency channels in common between the 12 radio frequency channels and the 42 radio frequency channels.

Systems, clients, servers, methods, and computer-readable media of varying scope are described herein. In addition to the aspects and advantages described in this summary, further aspects and advantages will become apparent by reference to the drawings and by reading the detailed description that follows.

### BRIEF DESCRIPTION OF THE DRAWINGS

FIG. 1 is a block diagram of an overview of a system of wireless communication between a beacon and a network base station receiver, according to an implementation;

FIG. 2 is a block diagram of apparatus that is capable of wireless telemetry communication between a beacon and a network base station receiver, according to an implementation;

FIG. 3 is a block diagram of apparatus that is capable of location tracking wireless communication between a beacon and a network base station receiver, according to an implementation;

FIG. 4 is a block diagram of apparatus that is capable of wireless telemetry communication between a beacon and a network base station receiver, according to an implementation;

FIG. 5 is a block diagram of apparatus that is capable of location tracking wireless communication between a beacon and a network base station receiver, according to an implementation;

FIG. 6 is a block diagram of apparatus that is capable of wireless telemetry communication between a beacon and a network base station receiver, according to an implementation;

FIG. 7 is a block diagram of apparatus that is capable of location tracking wireless communication between a beacon and a network base station receiver, according to an implementation;

FIG. 8 is a flowchart of a method of wireless telemetry communication from a beacon to a network base station receiver, according to an implementation;

FIG. 9 is a flowchart of a method of wireless location tracking communication from a beacon to a network base station receiver, according to an implementation;

FIG. 10 is a flowchart of a method of wireless telemetry communication at a network base station receiver, according to an implementation;

FIG. 11 is a flowchart of a method of wireless location tracking communication at a network base station receiver, according to an implementation;

FIG. 12 illustrates an example of a general computer environment useful in the context of FIG. 16, according to an implementation;

FIG. 13 is a block diagram of a telemetry beacon hardware environment in which implementations can be practiced;

FIG. 14 is a block diagram of a location tracking beacon hardware environment in which implementations can be practiced;

FIG. 15 is a block diagram of a network base station receiver hardware environment in which implementations can be practiced;

FIG. 16 is a block diagram of a system including a network, network base station receiver hardware environments and a beacon in which implementations can be practiced;

FIG. 17 is a diagram of OSI Layers for a HIA mini-burst;

FIG. 18 is a diagram of OSI Layers for a REG burst;

FIG. 19 is a diagram of OSI Layers for a LOC burst;

FIG. 20 is a diagram of OSI link layers of a SIM packet;

FIG. 21A is a diagram of HIA sync time;

FIG. 21B is a diagram of LOC sync time;

FIG. 22 is a diagram of Galois configuration of LFSR to generate an M-sequence;

FIG. 23 is a flowchart of LOC channel sequence generation per CSN;

FIG. 24 is a flowchart of SIM channel sequence generation per given CSN and WIN;

FIG. 25 is a diagram of a protocol stack for HIA burst;

FIG. 26 is a diagram of a protocol stack for a REG mini-burst;

FIG. 27 is a diagram of an encapsulation of a Message into the Network Layer;

FIG. 28 is a diagram of a protocol Stack for L0 burst;

FIG. 29 is a diagram of a LOC Middle mini-burst;

FIG. 30 is a diagram of a LOC Lower mini-burst;

FIG. 31 is a diagram of a LOC upper mini-burst;

FIG. 32 is a diagram of a LOC Lower mini-burst; and

FIG. 32 is a diagram of an encapsulation of Network and Transport Layer into a Data Link Layer for a SIM burst.

### DETAILED DESCRIPTION

In the following detailed description, reference is made to the accompanying drawings that form a part hereof, and in which is shown by way of illustration specific implementations which may be practiced. These implementations are described in sufficient detail to enable those skilled in the art to practice the implementations, and it is to be understood that other implementations may be utilized and that logical, mechanical, electrical and other changes may be made without departing from the scope of the implementations. The following detailed description is, therefore, not to be taken in a limiting sense.

The detailed description is divided into five sections. In the first section, a system level overview is described. In the second section, implementations of apparatus are described. In the third section, implementations of methods are described. In the fourth section, hardware and the operating environments in conjunction with which implementations may be practiced are described. In the fourth section, implementations of the protocol are described. In the fifth section, a conclusion of the detailed description is provided.

### System Level Overview

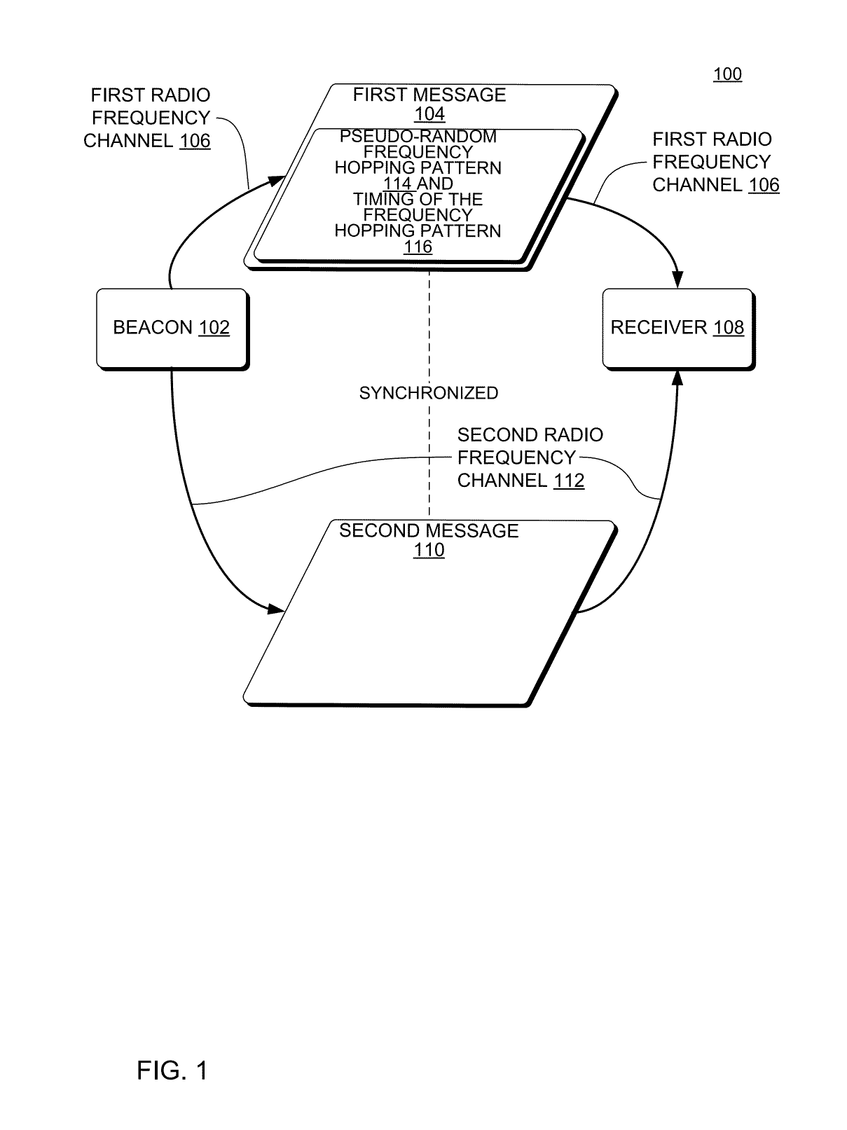

FIG. 1 is a block diagram of an overview of a system 100 of wireless communication between a beacon and a network base station receiver, according to an implementation. System 100 provides a bifurcated protocol to efficiently establish communications over radio frequencies.

System 100 includes a beacon 102 that is capable of transmitting a first message 104 on a first radio frequency channel 106. The first message 104 provides a notice to a network base station receiver 108 of the beacon 102. The beacon 102 is also capable thereafter of transmitting a second message 110 on a second radio frequency channel 112. The first message 110 provides to the network base station receiver 108 information that is necessary for the network base station receiver 108 to grant network access to the beacon 102, such as a pseudo-random frequency hopping pattern 114 and timing 116 of the pseudo-random frequency hopping pattern. The second radio frequency channel 112 is in the pseudo-random frequency hopping pattern 114. In addition, the second message 110 is synchronized to the first message 104 through the pseudo-random frequency hopping pattern 114 and the timing of the pseudo-random frequency hopping pattern 116 that are referenced by both the beacon 102 and the network base station receiver 108 in the transmission of the second message 110. In one example, the pseudo-random frequency hopping pattern 114 includes 42 radio frequencies.

In system 100, network access is bifurcated using two different transmissions (i.e. first message 104 and the second message 110) and two different communications channels (i.e. the first radio frequency 106 and the second radio frequency channel 112). The first message 106 provides the network with a means of detection of the beacon 102 that notifies the network of the presence on a beacon 102 and the intention of the beacon 102 to access the network. The second message 110 provides the network with a means to identify the beacon 102 and to receive additional information that may be necessary to grant network access to the beacon. By transmitting the beacon 102 identification and additional network access information in the second message 110 instead of the first message 104 permits the duration of the first message 104 to be reduced. In the case where the network is required to provide access to a large number of beacons 102, the reduction of the duration of the first message 104 allows the number of radio frequency channels that are used to initiate network access by a beacon 102 to be reduced. This reduction in the number of radio frequency channels used to initiate network access allows the number of network base station receivers 108 to be reduced resulting in a reduction in network equipment cost and network operating cost.

The first message 104 is a short transmission that does not include a serial number of the beacon 102. A large number of beacons 102 that require infrequent network access may share a small number of network resources and may gain access to the network resources when required. The use of only a small number of network resources is achieved by minimizing the duration of the transmission of the first message 104 by the beacon 102 required to notify the network of the intention of the beacon 102 to access the network. The shorter duration of the transmission of the first message 104 allows a large number of beacons 102 to be supported with a small number of radio frequency channels. With only a small number of radio frequency channels used, the cost to deploy and operate the network is reduced. A large number of beacons 102 that require infrequent access to the network of which the network base station receiver 108 is a part can share a small number of network resources and can gain access to the network resources when required. The use of only a small number of network resources is achieved by minimizing the duration of the transmission of the first message 104 by the beacon 102 that is required to notify the network of the intention of the beacon 102 to access the network. The shorter duration of the transmission of the first message 104 allows a large number of beacons 102 to be supported with a small number of radio frequency channels. With only a small number of radio frequency channels used, the cost to deploy and operate the network base station receiver 108 and the network to which the network base station receiver 108 is coupled is reduced.

In some implementations, the first message 104 is transmitted four times on different radio frequency channels by the beacon 102 and the second message 110 is transmitted two times by the beacon 102 in order to ensure receipt of the first message 104 and the second message 110 under circumstances where receipt of the first message 104 and the second message 110 is not known to the beacon 102 because the network base station receiver 108 does not send an acknowledgement of the first message 104 and the second message 110. The transmission of the first message 104 four times and the transmission of the second message 110 two times is reasonably calculated to ensure receipt of the first message 104 and the second message 110 by the network base station receiver 108 without an excessive number of unnecessary transmissions of the first message 104 and the second message 110.

In some implementations, the first message 104 is transmitted based on another pseudo-random frequency hopping pattern and timing of the other pseudo-random frequency hopping pattern that are stored in both the beacon 102 and the network base station receiver 108. In one example the other pseudo-random frequency hopping pattern has twelve radio frequencies.

The first message 104 is also known as an HIA transmission. The beacon 102 shall transmit in the HIA transmission an HIA burst. The HIA burst shall consist of four HIA mini-bursts. Each of the HIA mini-bursts notifies the network base station receiver 108 of the presence of the beacon 102 within range of the network base station receiver 108 and notifies the network base station receiver 108 that the beacon 102 will soon transmit a REG burst. A minimum of one network base station receiver 108 is required to receive at least one of the HIA.

The second message 110 is also known as a REG transmission. The beacon 102 shall transmit in the REG transmission a REG burst. The REG burst shall consist of two REG mini-bursts. The REG mini-bursts identifies the beacon 102 by the serial number (WIN) of the beacon 102 and notifies the network base station receiver 108 of the beacon 102's imminent to transmission of either a series of LOC bursts or a series of SIM bursts or no additional bursts. A minimum of one network base station receiver 108 monitoring site are required to receive at least one of the REG mini-bursts.

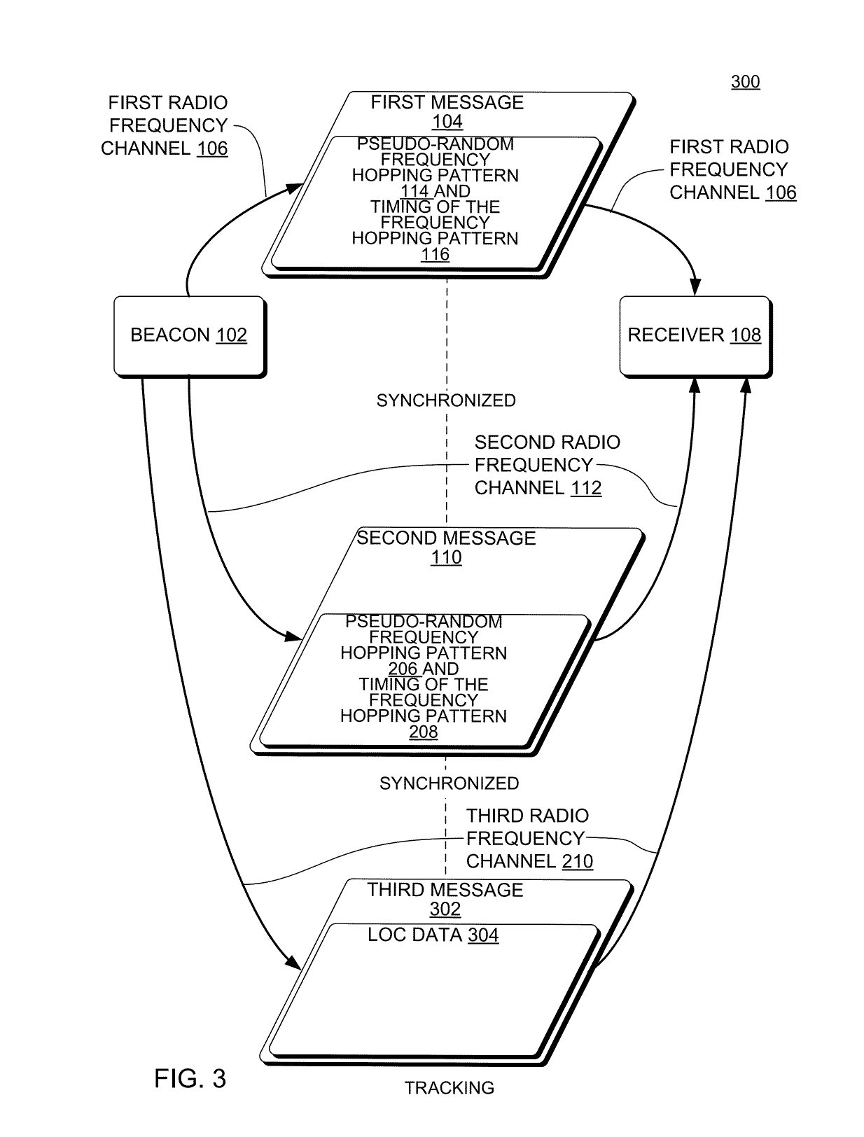

In location tracking applications (FIGS. 3, 5, 7, 9 and 11), the beacon 102 shall transmit a series of LOC bursts. Each burst includes of one of the four different types of LOC bursts: L0, L1, L2 or L3. Each LOC burst allows the network base station receiver 108 to determine the location of the beacon 102. Normally the LOC burst must be received by a minimum of three network base station receiver 108 monitoring sites. In some cases, the location of the beacon 102 can be determined if the LOC burst is received by only one or only two network base station receiver 108 monitoring sites.

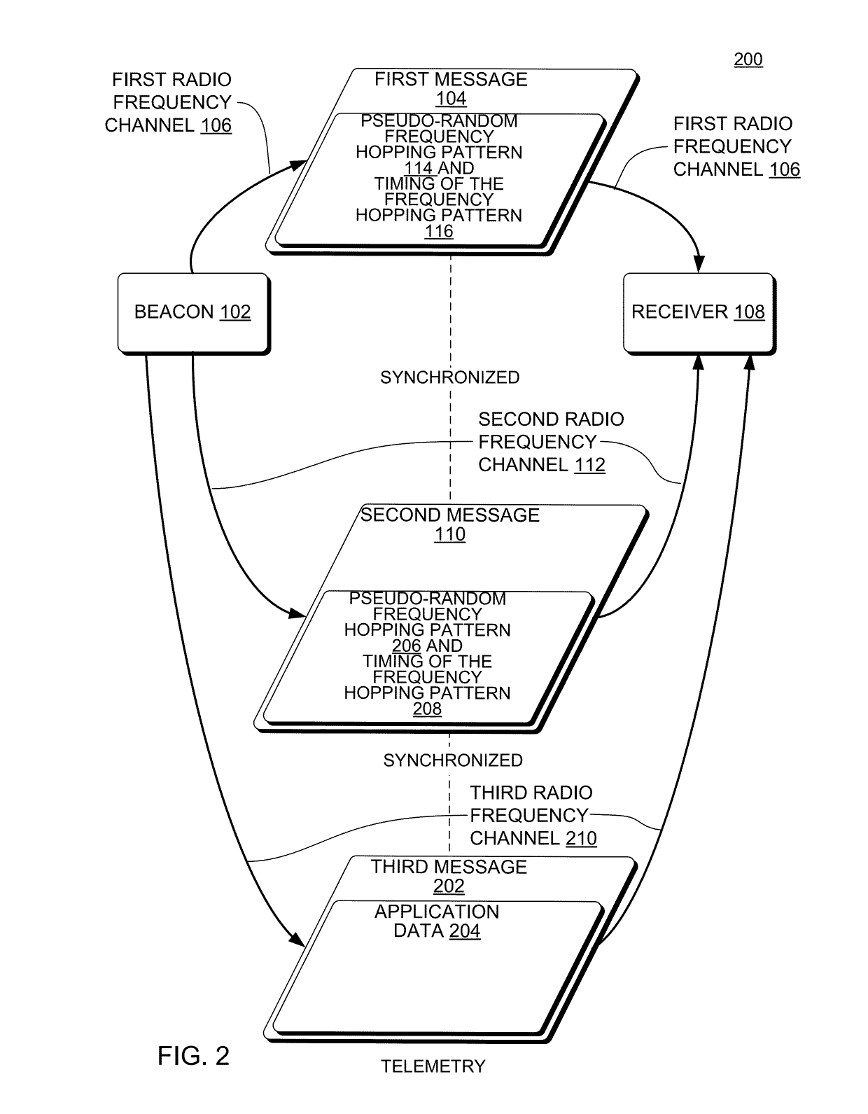

In telemetry applications (FIGS. 2, 4, 6, 8 and 10), the beacon 102 shall transmit a SIM packet to carry up to 260 bytes of data.

While the system 100 is not limited to any particular beacon 102, a first message 104, a first radio frequency channel 106, receiver 108, a second message 110, a second radio frequency channel 112 and information 114 that is necessary for the network base station receiver to grant network access to the beacon 102, for sake of clarity a simplified beacon 102, first message 104, first radio frequency channel 106, receiver 108, second message 110, second radio frequency channel 112, pseudo-random frequency hopping pattern 114 and timing 116 of the pseudo-random frequency hopping pattern 116 are described. The network base station receiver 108 is also known as a base station.

Conventional techniques use a single transmission of a longer duration that includes both the detection and identification of the beacon 102, which requires a larger number of communications channels resulting in a higher network equipment cost and a higher network operating cost.

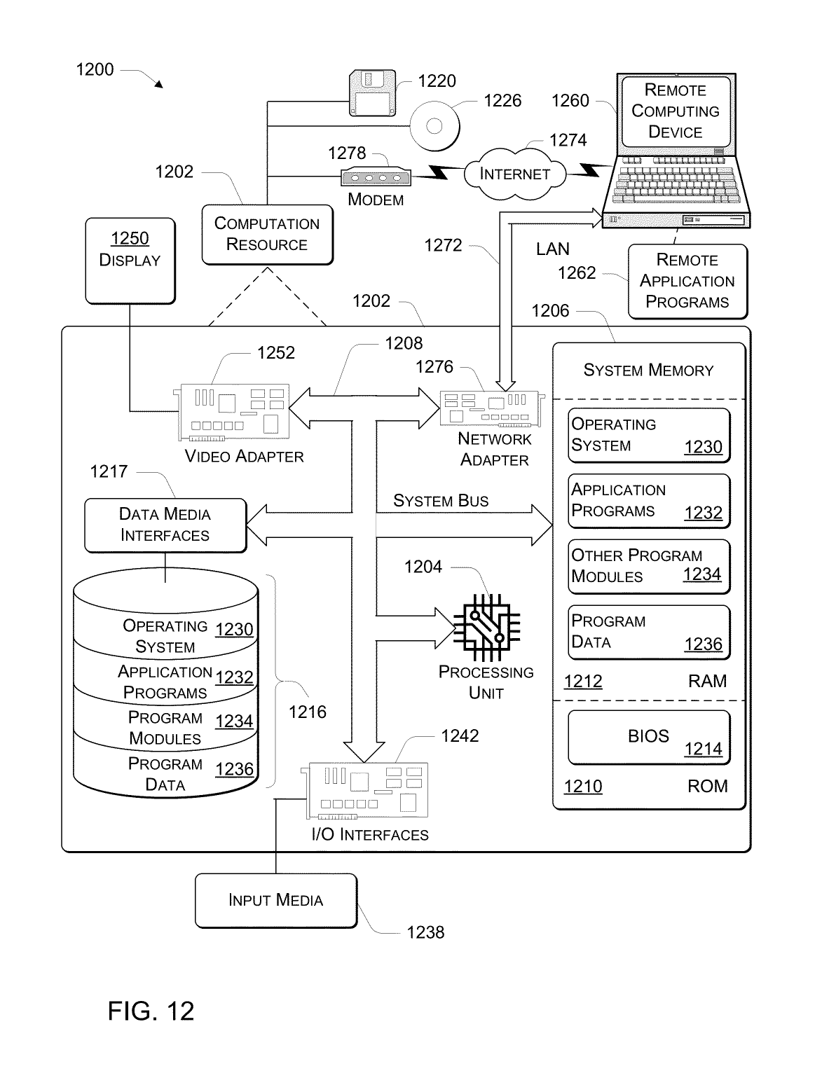

The system level overview of the operation of implementations is described above in this section of the detailed description. Some implementations can operate in a multi-processing, multi-threaded operating environment on a computer, such as general computer environment 1200 in FIG. 12.

In the disclosure herein, the beacon 102 to the network base station receiver 108 are asynchronous because there is no synchronization between the beacon 102 and the network base station receiver 108. However, the transmissions between the beacon 102 and the network base station receiver 108 can be synchronized.

### Apparatus

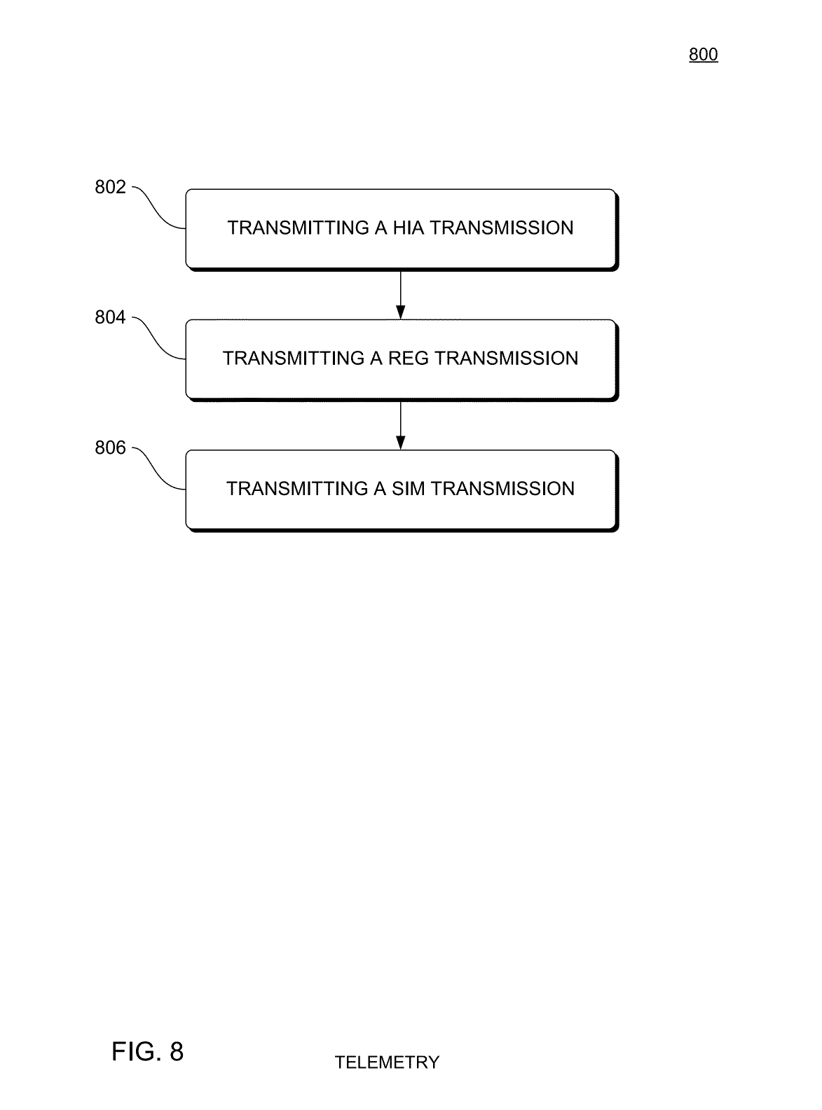

Referring to FIGS. 2-7, particular implementations are described in conjunction with the system overview in FIG. 1 and the methods described in conjunction with FIGS. 8-11.

FIG. 2 is a block diagram of apparatus 200 capable of wireless telemetry communication between a beacon and a network base station receiver, according to an implementation. In apparatus 200, the beacon 102 is operable to transmit to the network base station receiver 108 a third message 202. The second message 110 includes a pseudo-random frequency hopping pattern 206 and timing 208 of the pseudo-random frequency hopping pattern 206. A third radio frequency channel 210 is in the pseudo-random frequency hopping pattern 206.

The third message 202 is transmitted on a third radio frequency channel 210 of the second pseudo-random frequency hopping pattern 206 and the timing 208 of the pseudo-random frequency hopping pattern, and thus the third message 202 is synchronized to the second message 110 that are referenced by both the beacon 102 and the network base station receiver 108 in the transmission of the third message 202.

The third message 202 includes data 204. In some implementations, the data 204 includes application-specific data such as remote meter reading, smart grid, intelligent traffic signs, automotive, road condition telemetry, vending machine reporting and or/road construction equipment reporting. The third message 202 does not includes a serial number of the beacon 102, information representative of the radio frequencies of the pseudo-random frequency hopping patterns 114 and 206 or information representative of the timing 116 and 208 of the frequency hopping patterns.

Apparatus 200 provides exchange of information (i.e. data 204) from the beacon 102 to the network base station receiver 108 using a wireless communications channel (i.e. the third radio frequency channel 210) which has no conflict with the radio frequency channels (i.e. the first radio frequency channel 106 and the second radio frequency channel 112) over which communication between the beacon 102 and the network base station receiver 108 is established. The first message 104, the second message 110 and the third message 202 in the context of the protocol permits the beacon 102 to gain access to the network that the network base station receiver 108 that allows for the identification of the beacon 102 and allows for the transmission of data 204 from the beacon 102 to the network and from the network to the beacon.

In some implementations, the network base station receiver 108 is operable to transmit an acknowledgement to the beacon 102 after receiving the third message 202 and the beacon 102 is operable to attempt receipt of an acknowledgement transmission from the network base station receiver 108 after transmission of the third message 202 and the beacon 102 is operable to retransmit first message 104, the second message 110 and the third message 202 when no acknowledgement transmission by the beacon 102 from the network base station receiver 108 is received after a period of time.

In some implementations, the beacon 102 is operable to transmit the first message 104 and the second message 110 without waiting or delaying any further operations for an acknowledgement message from the network base station receiver 108 of the first message 104 and the second message 110.

In some implementations, the first message 104 includes notice that the network base station receiver 108 is in range of the beacon 102 and the first message 104 includes a representation of imminent access to the beacon 102.

FIG. 3 is a block diagram of apparatus 300 capable of location tracking wireless communication between a beacon and a network base station receiver, according to an implementation. In apparatus 300, the beacon 102 is operable to transmit to the network base station receiver 108 a third message 302. The third message 302 is transmitted based on a second pseudo-random frequency hopping pattern 206 and a timing 208 of the pseudo-random frequency hopping pattern, and thus the third message 302 is synchronized to the second message 110 that are referenced by both the beacon 102 and the network base station receiver 108 in the transmission of the third message 302.

The third message 302 includes data 304. In some implementations, the data 304 is one of four types of location tracking (LOC) bursts: L0, L1, L2 or L3. The four LOC bursts are shown in Table 1. Each LOC burst consists of a combination of LOC Mini-bursts. There are three types of LOC Mini-bursts:

a. LOC Lower Mini-burst,
b. LOC Middle Mini-burst,
c. LOC Upper Mini-burst.

The beginning of the first LOC Middle Mini-burst in any one of the four LOC bursts is referred to as the LOC Sync Time.

The network base station receiver 108 determines the current location of the beacon 102 from the LOC burst transmissions, which provides the location tracking. In some implementations, the identification of the beacon 102 is be linked to the registration of the beacon 102 by way of the time of the LOC burst transmission and channel number of the LOC burst. The LOC bursts are as short as possible in order to maximize capacity of the system 300.

TABLE 1

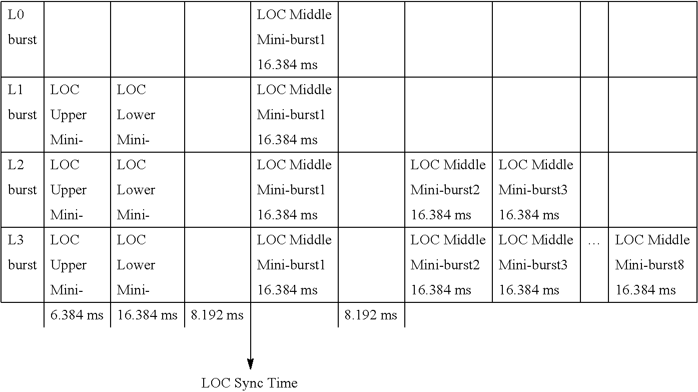

The third message 302 does not include a serial number of the beacon 102, information representative of the radio frequencies of the pseudo-random frequency hopping patterns 114 and 206 or information representative of the timing 116 and 208 of the frequency hopping patterns.

In some implementations, the network base station receiver 108 is operable to transmit an acknowledgement to the beacon 102 after receiving the third message 302 and the beacon 102 is operable to attempt receipt of an acknowledgement transmission from the network base station receiver 108 after transmission of the third message 302 and the beacon 102 is operable to retransmit first message 104, the second message 110 and the third message 302 when no acknowledgement transmission by the beacon 102 from the network base station receiver 108 is received after a period of time.

In some implementations, the beacon 102 is operable to transmit the first message 104 and the second message 110 without waiting or delaying any further operations for an acknowledgement message from the network base station receiver 108 of the first message 104 and the second message 110.

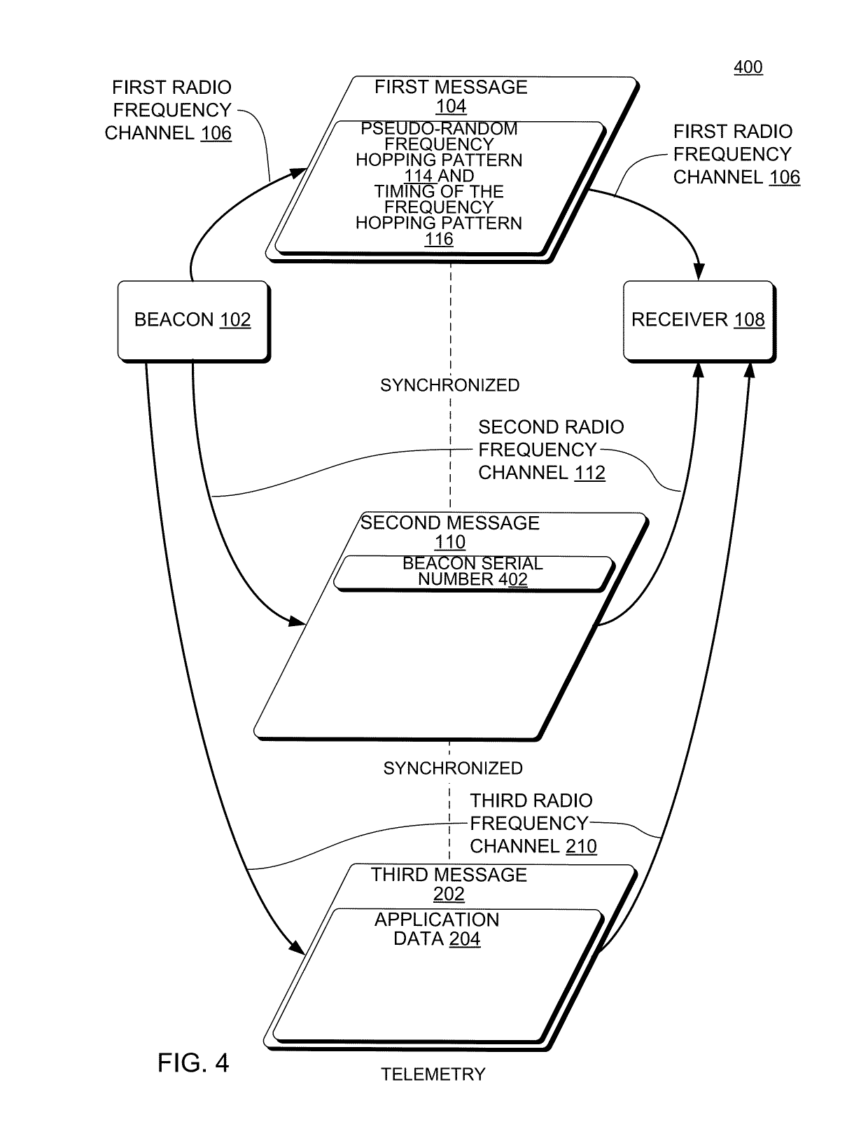

FIG. 4 is a block diagram of apparatus 400 capable of wireless telemetry communication between a beacon and a network base station receiver, according to an implementation. In apparatus 400, the beacon 102 is operable to transmit to the network base station receiver 108 the second message 110 having a unique identification of the beacon 102, such as a serial number 402 of the beacon 102. The beacon serial number 402 is used by the network base station receiver 108 to register the beacon as being active in the network of which the network base station receiver 108 is a part.

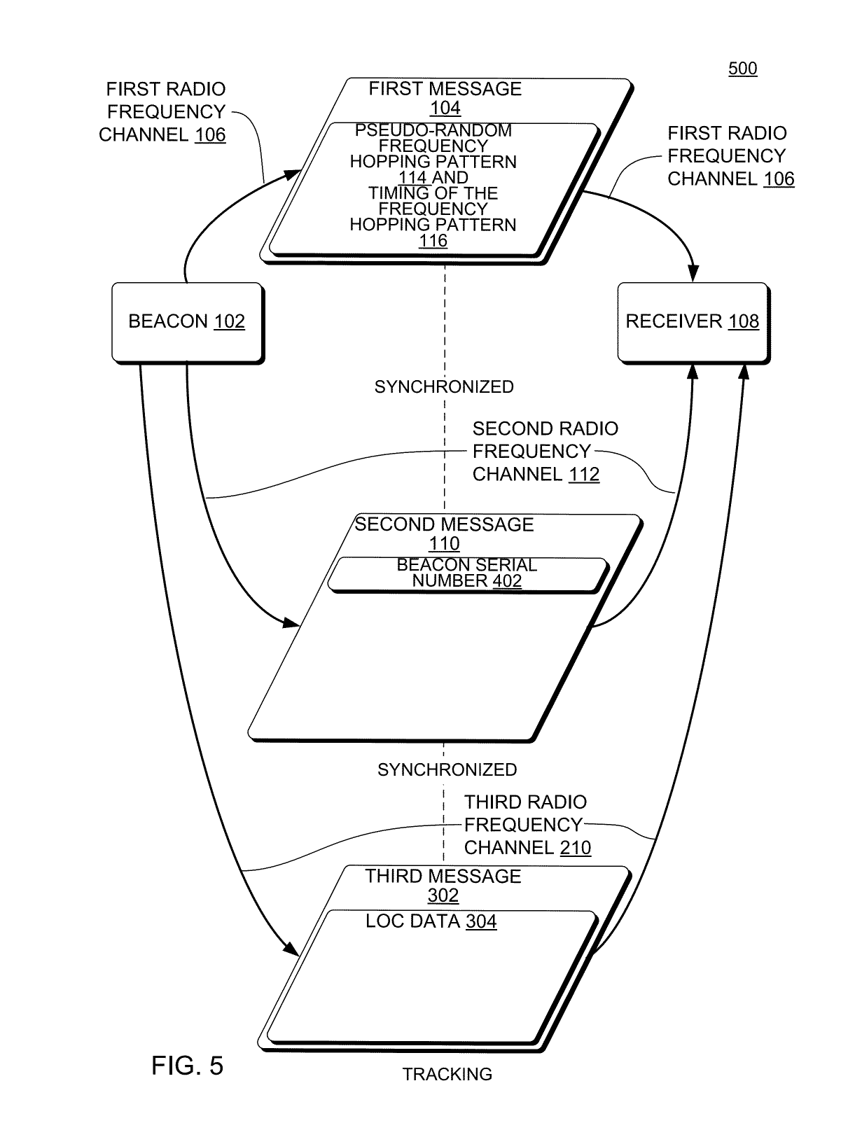

FIG. 5 is a block diagram of apparatus 500 capable of location tracking wireless communication between a beacon and a network base station receiver, according to an implementation. In apparatus 500, the beacon 102 is operable to transmit to the network base station receiver 108 the second message 110 having the unique identification of the beacon 102, such as the serial number 402 of the beacon 102. The beacon serial number 402 is used by the network base station receiver 108 to register the beacon as being active in the network of which the network base station receiver 108 is a part.

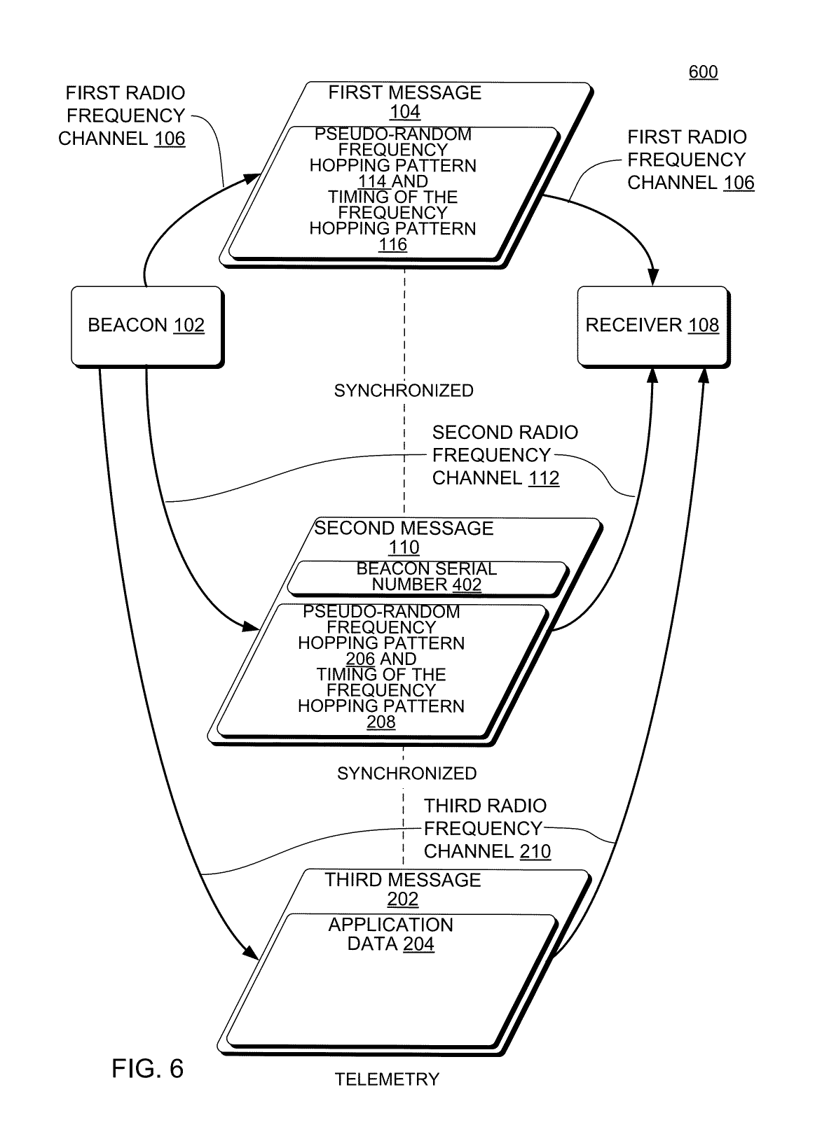

FIG. 6 is a block diagram of apparatus 600 capable of wireless telemetry communication between a beacon and a network base station receiver, according to an implementation. In apparatus 600, the beacon 102 is operable to transmit to the network base station receiver 108 the second message 110 having the unique identification of the beacon 102, such as the serial number 402 of the beacon 102. The beacon serial number 402 is used by the network base station receiver 108 to register the beacon 102 as being active in the network of which the network base station receiver 108 is a part. The second message 110 includes the pseudo-random frequency hopping pattern 206 and timing 208 of the pseudo-random frequency hopping pattern 206. Apparatus 600 provides a means for a large number of beacons 102 to gain network access of which the network base station receiver 108 is a part, and allows the network to receive data from the beacons 102 and to allow the beacons 102 to receive data from the network in a cost effective manner for applications that require exchange of small quantities of data 204 at a low cost. Funds received by an operator of the network the users of the beacons 102 can be used to pay for the deployment cost of the network, the operating cost of the network and to provide a profit to the service provider.

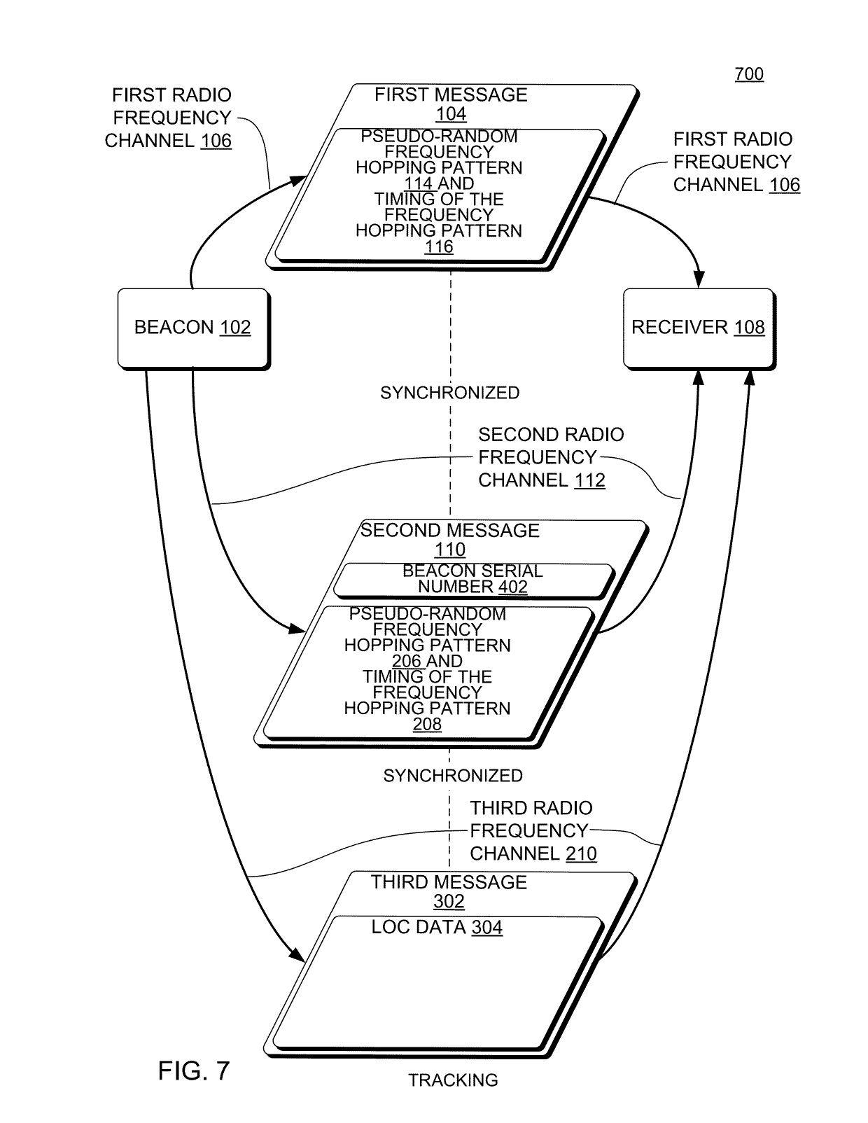

FIG. 7 is a block diagram of apparatus 700 capable of location tracking wireless communication between a beacon and a network base station receiver, according to an implementation. In apparatus 700, the beacon 102 is operable to transmit to the network base station receiver 108 the second message 110 having the unique identification of the beacon 102, such as the serial number 402 of the beacon 102. The beacon serial number 402 is used by the network base station receiver 108 to register the beacon 102 as being active in the network of which the network base station receiver 108 is a part. The second message 110 includes the pseudo-random frequency hopping pattern 206 and timing 208 of the pseudo-random frequency hopping pattern 206.

In implementations where the first message 104 of either apparatus 600 or apparatus 700 is transmitted based on the other pseudo-random frequency hopping pattern, the other pseudo-random frequency hopping pattern is known as the first pseudo-random frequency hopping pattern, the pseudo-random frequency hopping pattern 114 is known as the second pseudo-random frequency hopping pattern and the pseudo-random frequency hopping pattern 206 is known as the third pseudo-random frequency hopping pattern.

Apparatus components of the FIG. 2-7 can be embodied as computer hardware circuitry or as a computer-readable program, or a combination of both. More specifically, in the computer-readable program implementation, the programs can be structured in an object-orientation using an object-oriented language such as Java, Smalltalk or C++, and the programs can be structured in a procedural-orientation using a procedural language such as COBOL or C. The software components communicate in any of a number of means that are well-known to those skilled in the art, such as application program interfaces (API) or interprocess communication techniques such as remote procedure call (RPC), common object request broker architecture (CORBA), Component Object Model (COM), Distributed Component Object Model (DCOM), Distributed System Object Model (DSOM) and Remote Method Invocation (RMI). The components execute on as few as one computer as in general computer environment 1200 in FIG. 12, or on at least as many computers as there are components.

### Method Implementations

In the previous section, a system level overview of the operation of an implementation is described. In this section, the particular methods of such an implementation are described by reference to a series of flowcharts. Describing the methods by reference to a flowchart enables one skilled in the art to develop such programs, firmware, or hardware, including such processor-executable instructions to carry out the methods on suitable computers, executing the processor-executable instructions from computer-readable media. Similarly, the methods performed by the server computer programs, firmware, or hardware are also composed of processor-executable instructions. Methods 800-1100 can be performed by a program executing on, or performed by firmware or hardware that is a part of, a computer, such as general computer environment 1200 in FIG. 12.

FIG. 8 is a flowchart of a method 800 of wireless telemetry communication from a beacon to a network base station receiver, according to an implementation.

Method 800 includes transmitting a here-i-am (HIA) transmission from a beacon to a network base station receiver, at block 802. The HIA transmission is the first message 104 in FIG. 1. In some embodiments, the transmission is performed on a radio frequency channel of 12 radio frequency channels in which the 12 radio frequency channels are identified in a first pseudo-random frequency hopping pattern. In some implementations of block 802, the HIA transmission provides notice that the beacon is in range of the network base station receiver, provides a representation of imminent access to the network base station receiver and provides an notice that the beacon will transmit a registration (REG) transmission to the network base station receiver and the HIA transmission includes a second pseudo-random frequency hopping pattern, such as 114 in FIG. 1, and a timing of the second pseudo-random frequency hopping pattern, such as 116 in FIG. 1.

Method 800 includes transmitting the REG transmission, at block 804. The REG transmission is transmitted on one of the radio frequency channels in the second pseudo-random frequency hopping pattern, thus the REG transmission is synchronized to the HIA transmission on the second pseudo-random frequency hopping pattern. The REG transmission includes a serial number of beacon and a third pseudo-random frequency hopping pattern, such as 206 in FIG. 2, and a timing of the third pseudo-random frequency hopping pattern, such as 208 in FIG. 2.

Method 800 includes transmitting a short-and-instant telemetry messaging (SIM) transmission, at block 806. The SIM transmission is transmitted on one of the radio frequency channels in the third pseudo-random frequency hopping pattern, thus the SIM transmission is synchronized to the REG transmission on the third pseudo-random frequency hopping pattern. The SIM transmission includes data, the data including application-specific data such as remote meter reading, smart grid, intelligent traffic signs, automotive, road condition telemetry, vending machine reporting, road construction equipment reporting, the data not including the serial number of the beacon. The data does not include the information representative of the timing and information representative of any of the pseudo-random frequency hopping patterns.

The radio frequency channels of the first, second and third pseudo-random frequency hopping patterns are mutually exclusive.

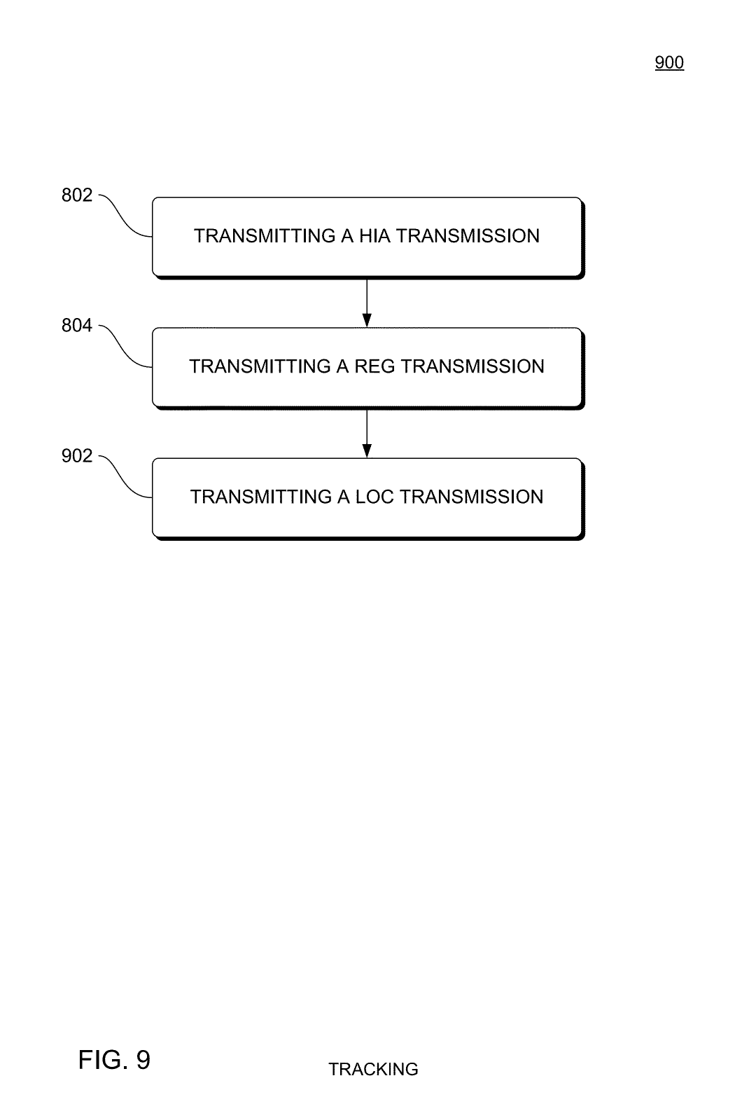

FIG. 9 is a flowchart of a method 900 of wireless location tracking communication from a beacon to a network base station receiver, according to an implementation.

Method 900 includes transmitting a here-i-am (HIA) transmission from a beacon to a network base station receiver, at block 802.

Method 900 includes transmitting the REG transmission, at block 804.

Method 900 includes transmitting a location messaging (LOC) transmission, at block 902. The LOC transmission is transmitted on one of the radio frequency channels in the third pseudo-random frequency hopping pattern, thus the LOC transmission is synchronized to the REG transmission on the third pseudo-random frequency hopping pattern. The LOC transmission includes one of the four types of location tracking (LOC) bursts. The data does not include the information representative of the timing or information representative of any of the pseudo-random frequency hopping patterns.

The radio frequency channels of the first, second and third pseudo-random frequency hopping patterns are mutually exclusive.

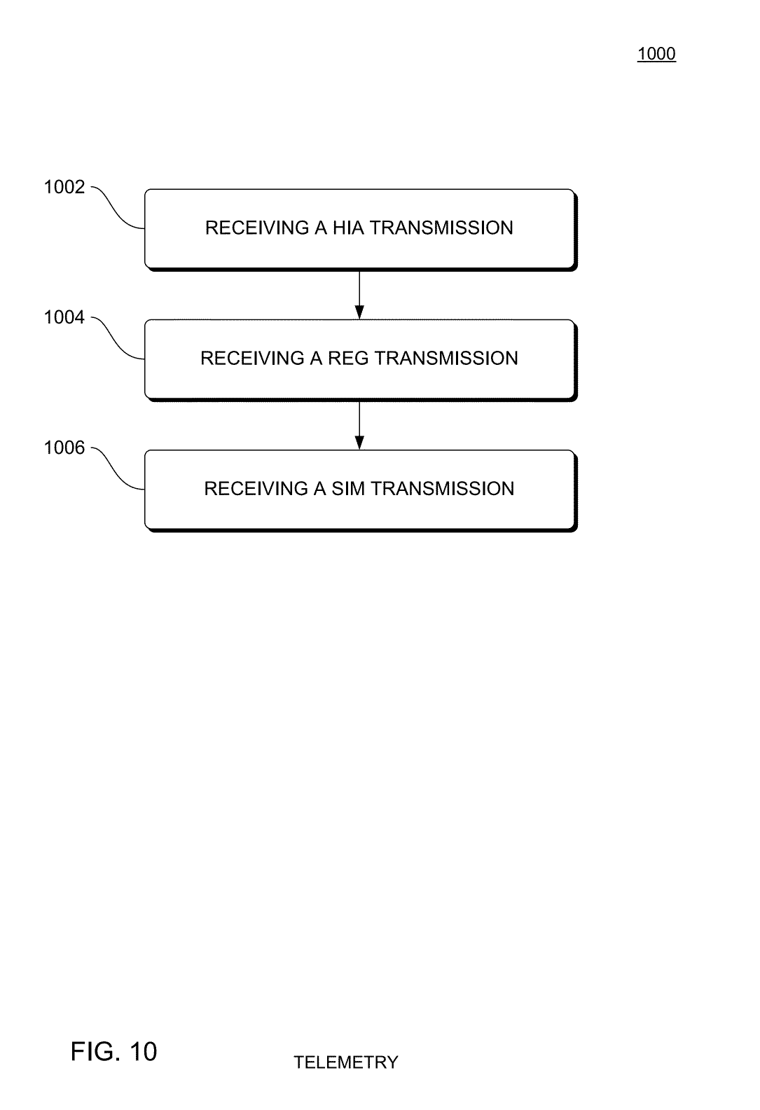

FIG. 10 is a flowchart of a method 1000 of wireless telemetry communication at a network base station receiver, according to an implementation.

Method 1000 includes receiving a here-i-am (HIA) transmission at a network base station receiver, at block 1002. The HIA transmission is the first message 104 in FIG. 1. In some embodiments, the transmission is received on a radio frequency channel of 12 radio frequency channels in which the 12 radio frequency channels are identified in a first pseudo-random frequency hopping pattern. The HIA transmission is interpreted as providing notice that the beacon is in range of the network base station receiver, providing notice a representation of imminent access to the network base station receiver and providing notice that the beacon will transmit a registration (REG) transmission to the network base station receiver. The HIA transmission includes a second pseudo-random frequency hopping pattern, such as 114 in FIG. 1, and a timing of the second pseudo-random frequency hopping pattern, such as 116 in FIG. 1. The HIA transmission is a short transmission that does not include a serial number of the beacon.

Method 1000 includes receiving the REG transmission, at block 1004. The REG transmission is received on one of the radio frequency channels in the second pseudo-random frequency hopping pattern, thus the REG transmission is synchronized to the HIA transmission on the second pseudo-random frequency hopping pattern. The REG transmission includes a serial number of beacon and a third pseudo-random frequency hopping pattern, such as 206 in FIG. 2, and a timing of the third pseudo-random frequency hopping pattern, such as 208 in FIG. 2.

Method 1000 includes receiving a short-and-instant telemetry messaging (SIM) transmission, at block 1006. The SIM transmission is received on one of the radio frequency channels in the third pseudo-random frequency hopping pattern, thus the SIM transmission is synchronized to the REG transmission on the third pseudo-random frequency hopping pattern. The SIM transmission includes data, the data including application-specific data such as remote meter reading, smart grid, intelligent traffic signs, automotive, road condition telemetry, vending machine reporting, road construction equipment reporting, the data not including the serial number of the beacon. The data does not include the information representative of the timing and information representative of any of the pseudo-random frequency hopping patterns.

The radio frequency channels of the first, second and third pseudo-random frequency hopping patterns are mutually exclusive.

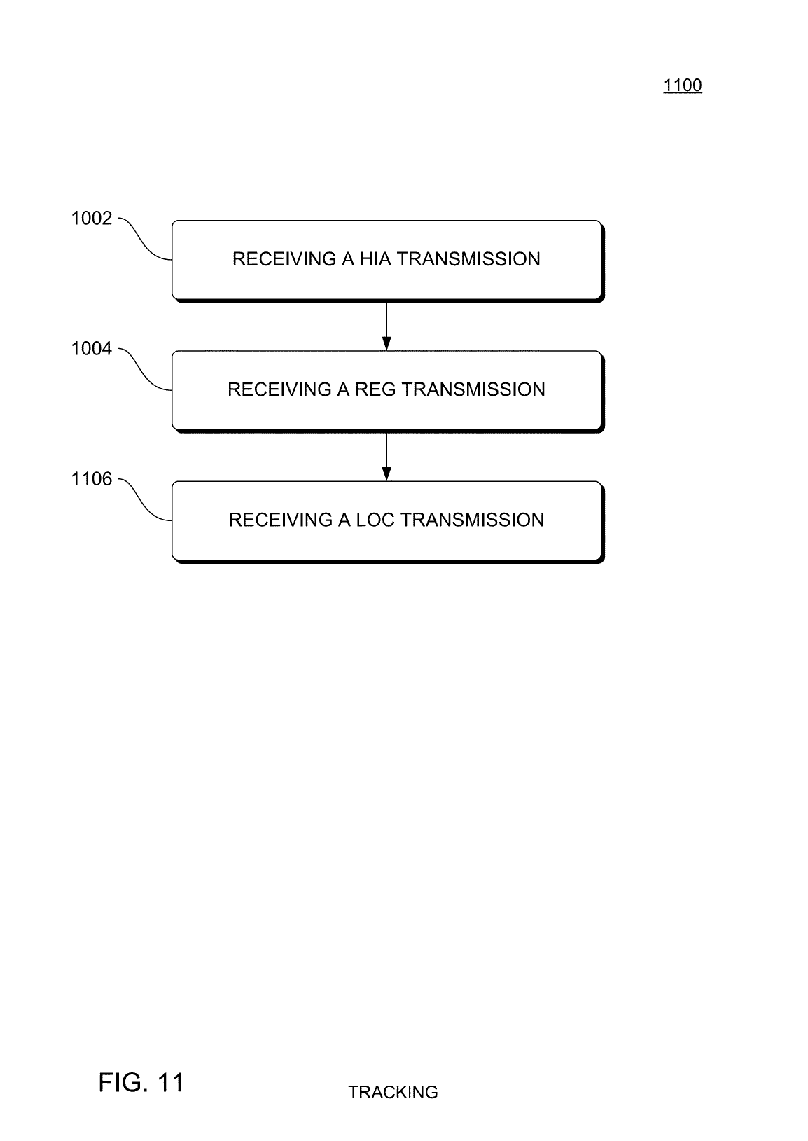

FIG. 11 is a flowchart of a method 1100 of wireless location tracking communication at a network base station receiver, according to an implementation.

Method 1100 includes receiving a here-i-am (HIA) transmission at a network base station receiver, at block 1002.

Method 1100 includes receiving the REG transmission, at block 1004.

Method 1100 includes receiving a location messaging (LOC) transmission, at block 1102. The LOC transmission is transmitted on one of the radio frequency channels in the third pseudo-random frequency hopping pattern, thus the LOC transmission is synchronized to the REG transmission on the third pseudo-random frequency hopping pattern. The LOC transmission includes one of the four types of location tracking (LOC) bursts. The data does not include the information representative of the timing or information representative of any of the pseudo-random frequency hopping patterns.

In some implementations, methods 800-1100 are implemented as a computer data signal embodied in a carrier wave, that represents a sequence of processor-executable instructions which, when executed by a processor, such as processing units 1204 in FIG. 12, cause the processor to perform the respective method. In other implementations, methods 800-1100 are implemented as a computer-accessible medium having processor-executable instructions capable of directing a processor, such as processing units 1204 in FIG. 12, to perform the respective method. In varying implementations, the medium is a magnetic medium, an electronic medium, or an optical medium.

### Hardware and Operating Environment

FIG. 12 is a block diagram of a hardware and operating environment 1200 in which different implementations can be practiced. The description of FIG. 12 provides an overview of computer hardware and a suitable computing environment in conjunction with which some implementations can be implemented. Implementations are described in terms of a computer executing processor-executable instructions. However, some implementations can be implemented entirely in computer hardware in which the processor-executable instructions are implemented in read-only memory. Some implementations can also be implemented in client/server computing environments where remote devices that perform tasks are linked through a communications network. Program modules can be located in both local and remote memory storage devices in a distributed computing environment.

FIG. 12 illustrates an example of a general computer environment 1200 useful in the context of FIG. 1-11, according to an implementation. The general computer environment 1200 includes a computation resource 1202 capable of implementing the processes described herein. It will be appreciated that other devices can alternatively used that include more components, or fewer components, than those illustrated in FIG. 12.

The illustrated operating environment 1200 is only one example of a suitable operating environment, and the example described with reference to FIG. 12 is not intended to suggest any limitation as to the scope of use or functionality of the implementations of this disclosure. Other well-known computing systems, environments, and/or configurations can be suitable for implementation and/or application of the subject matter disclosed herein.

The computation resource 1202 includes one or more processors or processing units 1204, a system memory 1206, and a bus 1208 that couples various system components including the system memory 1206 to processor(s) 1204 and other elements in the environment 1200. The bus 1208 represents one or more of any of several types of bus structures, including a memory bus or memory controller, a peripheral bus, an accelerated graphics port and a processor or local bus using any of a variety of bus architectures, and can be compatible with SCSI (small computer system interconnect), or other conventional bus architectures and protocols.

The system memory 1206 includes nonvolatile read-only memory (ROM) 1210 and random access memory (RAM) 1212, which can or can not include volatile memory elements. A basic input/output system (BIOS) 1214, containing the elementary routines that help to transfer information between elements within computation resource 1202 and with external items, typically invoked into operating memory during start-up, is stored in ROM 1210.

The computation resource 1202 further can include a non-volatile read/write memory 1216, represented in FIG. 12 as a hard disk drive, coupled to bus 1208 via a data media interface 1217 (e.g., a SCSI, ATA, or other type of interface); a magnetic disk drive (not shown) for reading from, and/or writing to, a removable magnetic disk 1220 and an optical disk drive (not shown) for reading from, and/or writing to, a removable optical disk 1226 such as a CD, DVD, or other optical media.

The non-volatile read/write memory 1216 and associated computer-readable media provide nonvolatile storage of processor-readable instructions, data structures, program modules and other data for the computation resource 1202. Although the exemplary environment 1200 is described herein as employing a non-volatile read/write memory 1216, a removable magnetic disk 1220 and a removable optical disk 1226, it will be appreciated by those skilled in the art that other types of computer-readable media which can store data that is accessible by a computer, such as magnetic cassettes, FLASH memory cards, random access memories (RAMs), read only memories (ROM), and the like, can also be used in the exemplary operating environment.

A number of program modules can be stored via the non-volatile read/write memory 1216, magnetic disk 1220, optical disk 1226, ROM 1210, or RAM 1212, including an operating system 1230, one or more application programs 1232, other program modules 1234 and program data 1236. Examples of computer operating systems conventionally employed for some types of three-dimensional and/or two-dimensional medical image data include the NUCLEUS® operating system, the LINUX® operating system, and others, for example, providing capability for supporting application programs 1232 using, for example, code modules written in the C++® computer programming language.

A user can enter commands and information into computation resource 1202 through input devices such as input media 1238 (e.g., keyboard/keypad, tactile input or pointing device, mouse, foot-operated switching apparatus, joystick, touchscreen or touchpad, microphone, antenna etc.). Such input devices 1238 are coupled to the processing unit 1204 through a conventional input/output interface 1242 that is, in turn, coupled to the system bus. A monitor 1250 or other type of display device is also coupled to the system bus 1208 via an interface, such as a video adapter 1252.

The computation resource 1202 can include capability for operating in a networked environment using logical connections to one or more remote computers, such as a remote computer 1260. The remote computer 1260 can be a personal computer, a server, a router, a network PC, a peer device or other common network node, and typically includes many or all of the elements described above relative to the computation resource 1202. In a networked environment, program modules depicted relative to the computation resource 1202, or portions thereof, can be stored in a remote memory storage device such as can be associated with the remote computer 1260. By way of example, remote application programs 1262 reside on a memory device of the remote computer 1260. The logical connections represented in FIG. 12 can include interface capabilities, a storage area network (SAN, not illustrated in FIG. 12), local area network (LAN) 1272 and/or a wide area network (WAN) 1274, but can also include other networks.

Such networking environments are commonplace in modern computer systems, and in association with intranets and the Internet. In certain implementations, the computation resource 1202 executes an Internet Web browser program (which can optionally be integrated into the operating system 1230), such as the “Internet Explorer®” Web browser manufactured and distributed by the Microsoft Corporation of Redmond, Wash.

When used in a LAN-coupled environment, the computation resource 1202 communicates with or through the local area network 1272 via a network interface or adapter 1276. When used in a WAN-coupled environment, the computation resource 1202 typically includes interfaces, such as a modem 1278, or other apparatus, for establishing communications with or through the WAN 1274, such as the Internet. The modem 1278, which can be internal or external, is coupled to the system bus 1208 via a serial port interface.

In a networked environment, program modules depicted relative to the computation resource 1202, or portions thereof, can be stored in remote memory apparatus. It will be appreciated that the network connections shown are exemplary, and other means of establishing a communications link between various computer systems and elements can be used.

A user of a computer can operate in a networked environment using logical connections to one or more remote computers, such as a remote computer 1260, which can be a personal computer, a server, a router, a network PC, a peer device or other common network node. Typically, a remote computer 1260 includes many or all of the elements described above relative to the computer 1200 of FIG. 12.

The computation resource 1202 typically includes at least some form of computer-readable media. Computer-readable media can be any available media that can be accessed by the computation resource 1202. By way of example, and not limitation, computer-readable media can comprise computer storage media and communication media.

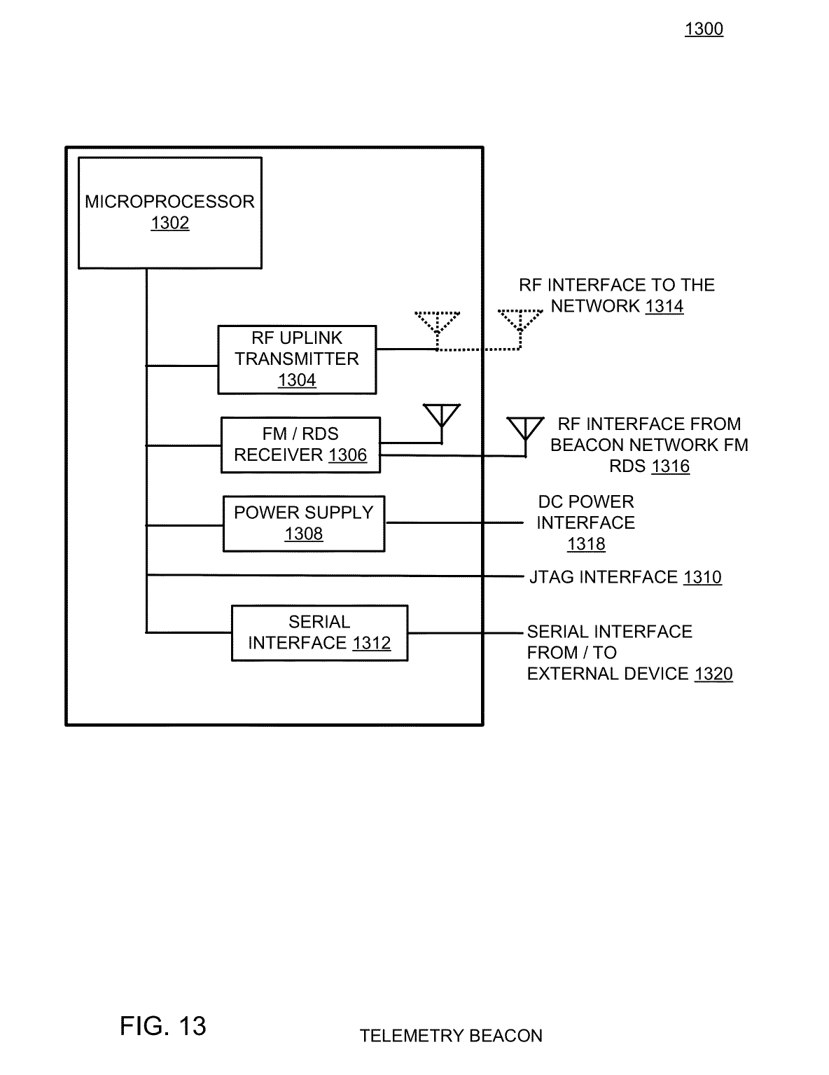

FIG. 13 is a block diagram of a telemetry beacon hardware environment 1300 in which implementations can be practiced. The telemetry beacon hardware environment 1300 is one example of beacon 102 and can perform method 800 in FIG. 8. The telemetry beacon hardware environment 1300 includes a microprocessor 1302 that is operably coupled to a radio frequency (RF) uplink transmitter 1304, a FM/RDS receiver 1306, a power supply 1308, a JTAG interface 1310 and a serial interface 1312. The RF uplink transmitter 1304 provides an RF interface 1314 to the network (not shown in FIG. 13.). The FM/RDS receiver 1306 provides an RF interface from a beacon network RM RDS (not shown in FIG. 13). The power supply 1308 is operably coupled to a DC power interface 1318. The serial interface 1312 is operably coupled to a serial interface 1320 from/to an external device (not shown in FIG. 13).

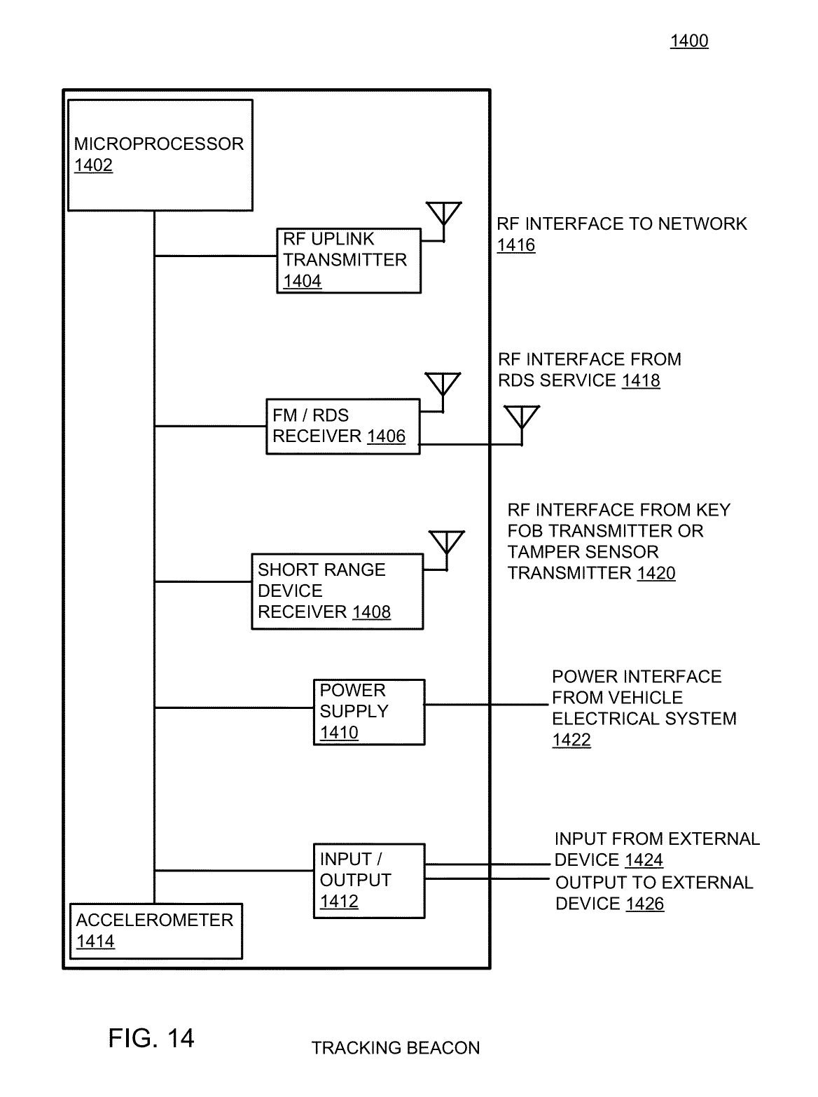

FIG. 14 is a block diagram of a location tracking beacon hardware environment 1400 in which implementations can be practiced. The location tracking beacon hardware environment 1400 is one example of beacon 102 and can perform method 900 in FIG. 9. The location tracking beacon hardware environment 1400 includes a microprocessor 1402 that is operably coupled to a radio frequency (RF) uplink transmitter 1404, a FM/RDS receiver 1406, a short range device receiver 1408, a power supply 1410 and am input/output interface 1312. The RF uplink transmitter 1404 provides an RF interface 1416 to the network (not shown in FIG. 13.). The FM/RDS receiver 1406 provides an RF interface 1418 from a beacon network RM RDS (not shown in FIG. 14). The short range device receiver 1408 provides an RF interface 1420 from a key fob transmitter or a tamper sensor transmitter (not shown in FIG. 14). The power supply 1410 is operably coupled to a power interface 1422 of a vehicle electrical system (not shown in FIG. 14). The input/output interface 1412 is operably coupled to a input 1424 from an external device (not shown in FIG. 14) and an output 1426 from an external device (not shown in FIG. 14).

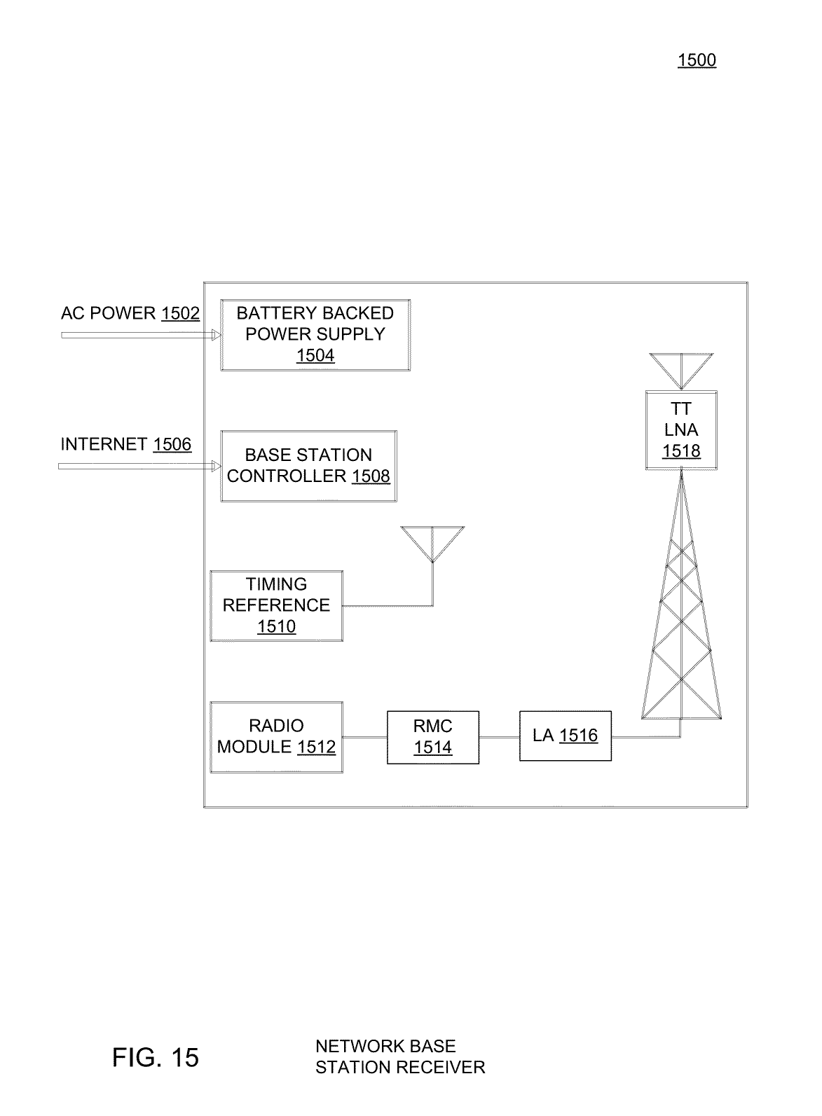

FIG. 15 is a block diagram of a network base station receiver hardware environment 1500 in which implementations can be practiced. The network base station receiver hardware environment 1500 is one example of network base station receiver 108 and can perform method 1000 in FIG. 10 and method 1100 in FIG. 11. The network base station receiver hardware environment 1500 receives alternating current power 1502 into a battery backed power supply 1504. The network base station receiver hardware environment 1500 receives data from the Internet 1506 a base station controller 1508. The network base station receiver hardware environment 1500 also includes a timing reference component 1510. The network base station receiver hardware environment 1500 also includes a radio module 1512 that is operably coupled to a RMC 1514, that is operably coupled to a LA 1516, that is operably coupled to TT LNA 1518.

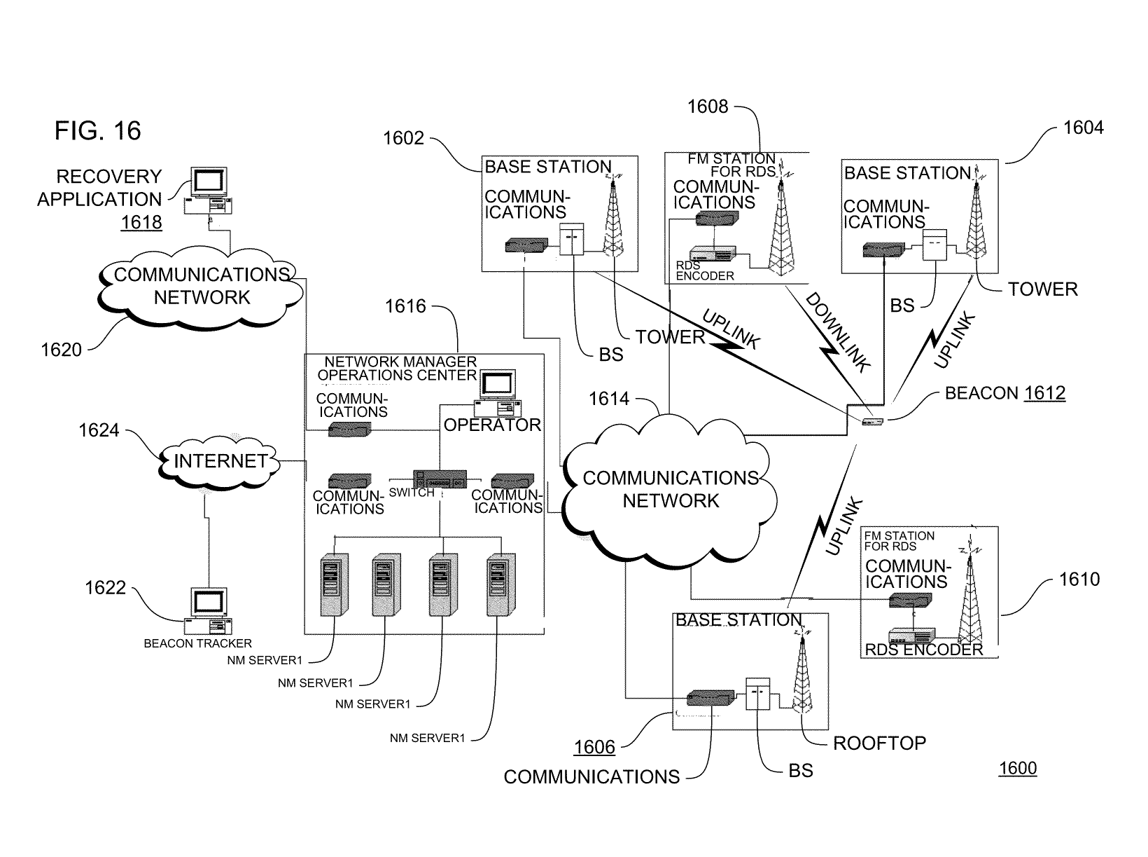

FIG. 16 is a block diagram of a system 1600 including a network, network base station receiver hardware environments and a beacon in which implementations can be practiced. System 1600 includes network base station receiver hardware environments 1602, 1604 and 1606 and FM stations for RDS 1608 and 1610 that are operable to communicate via radio frequency channels to a beacon 1612. The network base station receiver hardware environments 1602, 1604 and 1606 and FM stations for RDS 1608 and 1610 are operably coupled via to a communications network 1614 which is operably coupled to a network manager operations center 1616. The network manager operations center 1616 is operably coupled to a recovery application 1618 through a communications network 1620. The network manager operations center 1616 is operably coupled to a beacon tracker 1622 through the Internet 1624.

Computer storage media include volatile and nonvolatile, removable and non-removable media, implemented in any method or technology for storage of information, such as processor-readable instructions, data structures, program modules or other data. The term “computer storage media” includes, but is not limited to, RAM, ROM, EEPROM, FLASH memory or other memory technology, CD, DVD, or other optical storage, magnetic cassettes, magnetic tape, magnetic disk storage or other magnetic storage devices, or any other media which can be used to store computer-intelligible information and which can be accessed by the computation resource 1202.

Communication media typically embodies processor-executable instructions, data structures, program modules or other data, represented via, and determinable from, a modulated data signal, such as a carrier wave or other transport mechanism, and includes any information delivery media. The term “modulated data signal” means a signal that has one or more of its characteristics set or changed in such a manner as to encode information in the signal in a fashion amenable to computer interpretation.

By way of example, and not limitation, communication media include wired media, such as wired network or direct-wired connections, and wireless media, such as acoustic, RF, infrared and other wireless media. The scope of the term computer-readable media includes combinations of any of the above.

### Implementations of the Protocol

Various implementations of the protocol are described without limiting this disclosure.

### HIA Burst

Each HIA burst indicates an upcoming transmission of a REG burst. Each HIA burst includes of four HIA mini-bursts. Each HIA mini-burst includes of two parts, a 16.384 ms detection burst followed by a data burst. The Detection burst can be used by the network to detect the beginning of the HIA Mini-Burs. In an HIA mini-burst, the Data burst consists of one HIA Data burst with duration of 16.384 ms. The Data burst contains 8 data bits: two bits are used to determine the type of mini-burst: HIA (00b) while the remaining 6 bits are used to transmit the Channel Sequence number (CSN).

Regardless of the type of mini-burst that is utilized by the HIA, the selection of the channels are pseudo-random. The HIA channel number in combination with the Channel Sequence number are used to identify which of the mini-bursts has been received. This information are used to determine the time at which the REG burst may be received. The Channel Sequence number is used to determine the REG mini-burst channel hopping pattern.

### HIA Mini-Burst

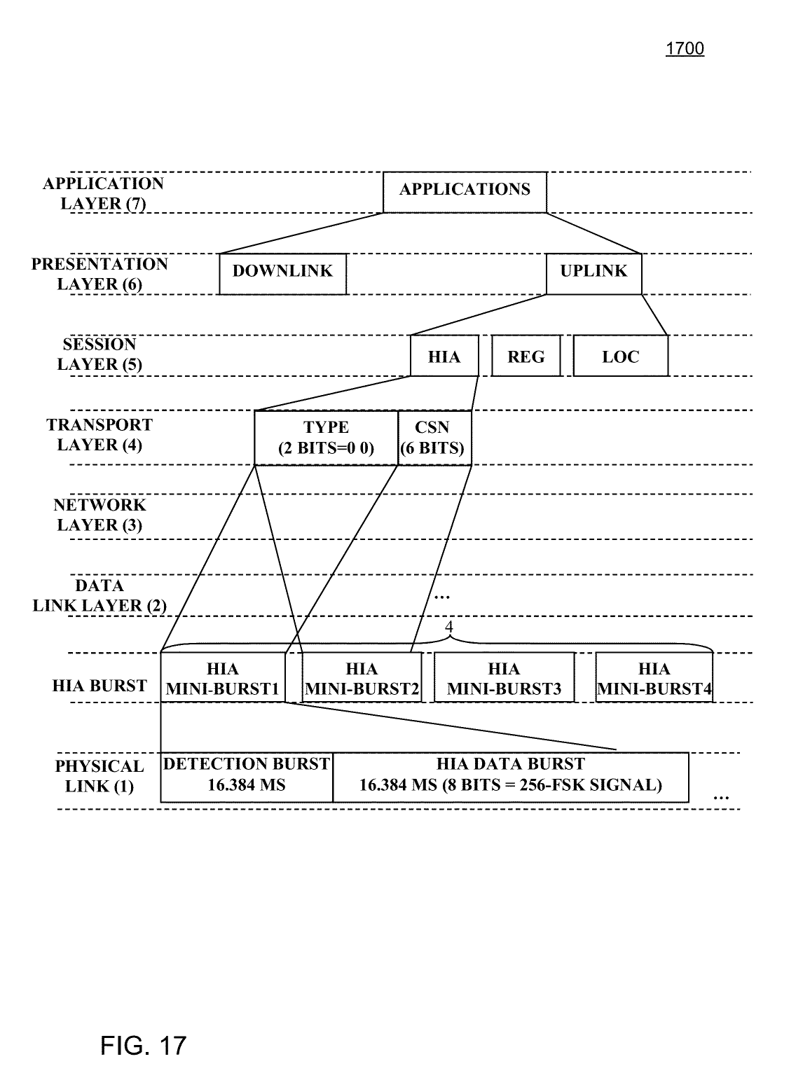

Each of the four HIA mini-bursts is transmitted sequentially with a 38.0 ms delay measured from the beginning of one HIA mini-burst to the beginning of the next HIA mini-burst. Each HIA mini-burst includes of two parts, a 16.384 ms Detection burst followed by one 16.384 ms HIA Data burst. The beginning of the first HIA mini-burst is referred to as HIA Sync Time. FIG. 17 shows all of the OSI layers for the HIA mini-burst.

### REG

The beacon 102 shall transmit a REG burst. The REG burst includes of two REG mini-bursts. Each of the two mini-bursts are transmitted sequentially with a 2 second delay measured from the beginning of the first mini-burst to the beginning of the second mini-burst. The selection of the REG channels is pseudo-random.

The Network shall assign radios, as necessary, to tune to the required registration channel at the required time to receive the REG mini-bursts. While the REG mini-burst is longer in duration than the HIA mini-burst, the required number of deployed radios is reduced by the fact that the channels are only monitored on an as-needed basis.

### REG Mini-Burst

Each REG mini-burst includes of a 196.608 millisecond REG Data burst, containing the following encoded information:

| | | |
|---|---|---|
| 1. | WIN | 32 bits |
| 2. | Data Message | 28 bits |
| 3. | Data Class | 4 bits |
| 4. | CRC check character | 8 bits |
| 5. | — | — |
| 6. | Total | 72 bits |

The beacon 102 Identification Number (WIN) shall uniquely identify the transmitting beacon 102. The network base station receiver 108 shall use this information to correctly interpret the identity and application of the transmitting beacon 102. No two beacons 102 shall have the same WIN.

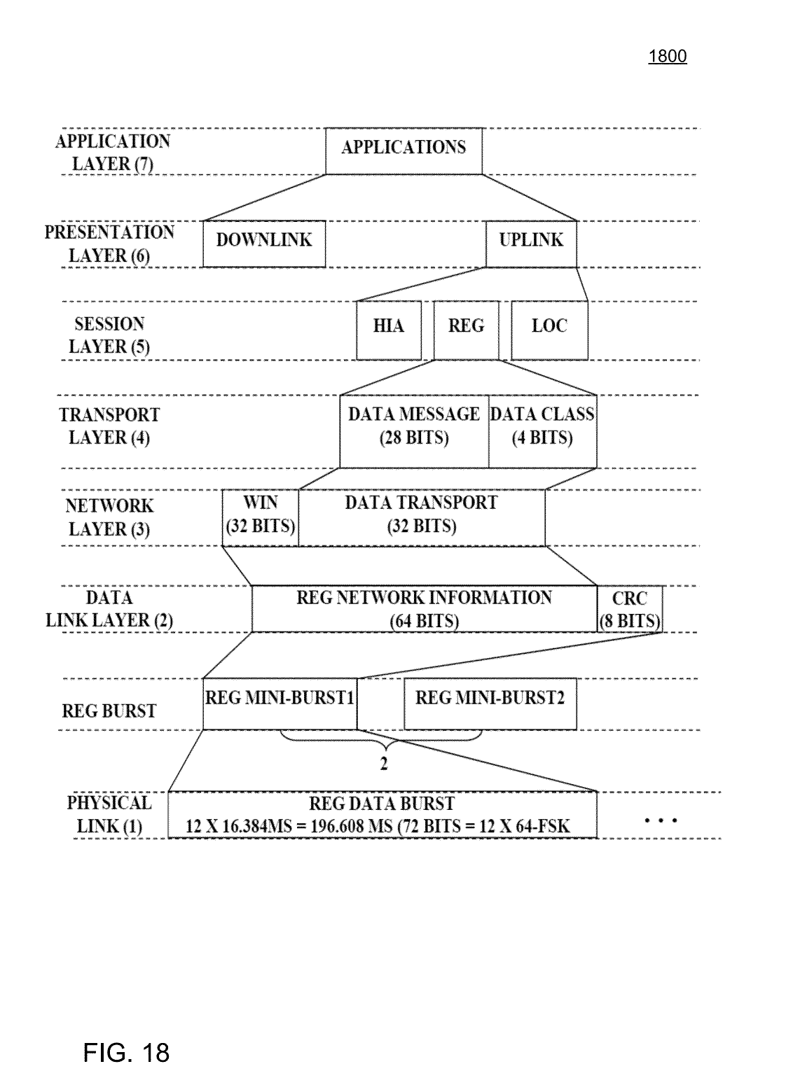

The Data Messages component is used for application specific data and is defined by the application and by the Data Class. The Data Class (4 bits long) defines how the bits in the Data Message are interpreted. Several Data Classes have been developed so far. FIG. 18 shows all OSI layers for the REG burst.

### LOC

The LOC burst used in the tracking application includes of one of the four types of LOC bursts: L0, L1, L2 or L3. Each LOC burst consists of a combination of LOC mini-bursts. There are three types of LOC mini-bursts:

LOC Lower mini-burst,

LOC Middle mini-burst,

LOC Upper mini-burst.

Each LOC burst are transmitted on one of the locate channels. The selection of the locate channels are pseudo-random. The beginning of the first LOC Middle Mini-burst in any one of the four LOC bursts is referred to as the LOC Sync Time.

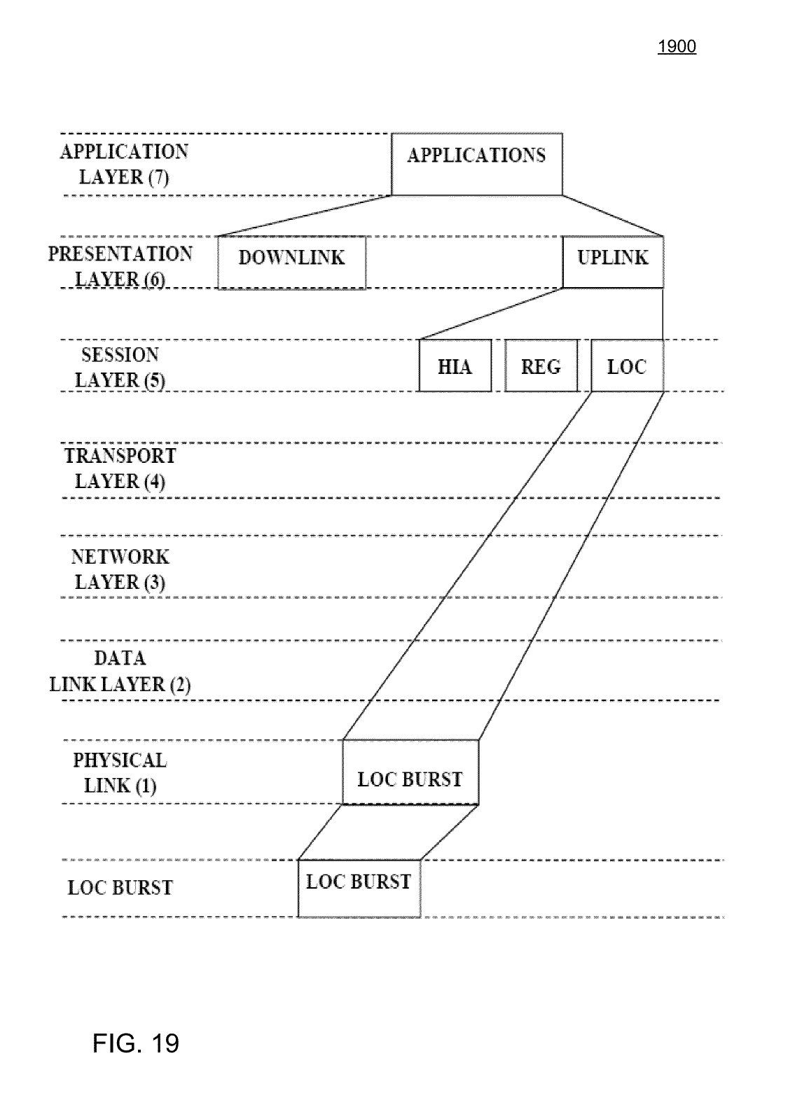

The network base station receiver 108 shall use the beacon 102's LOC burst transmissions to determine the location of the beacon 102. The identification of the beacon 102 can be linked to the beacon 102's registration by way of the time of the LOC burst transmission and channel number of the LOC burst. The LOC bursts are kept as short as possible in order to maximize the network base station receiver 108 capacity. FIG. 19 shows all of the OSI layers for the LOC Uplink protocol.

### SIM

The SIM uplink transmission is able to carry up to 260 bytes of data. The data are partitioned into 9-byte blocks. If the length of the data, in bytes, is not an integer multiple of 9, then a sufficient number of bytes with a value of 0x00 are appended at the end.

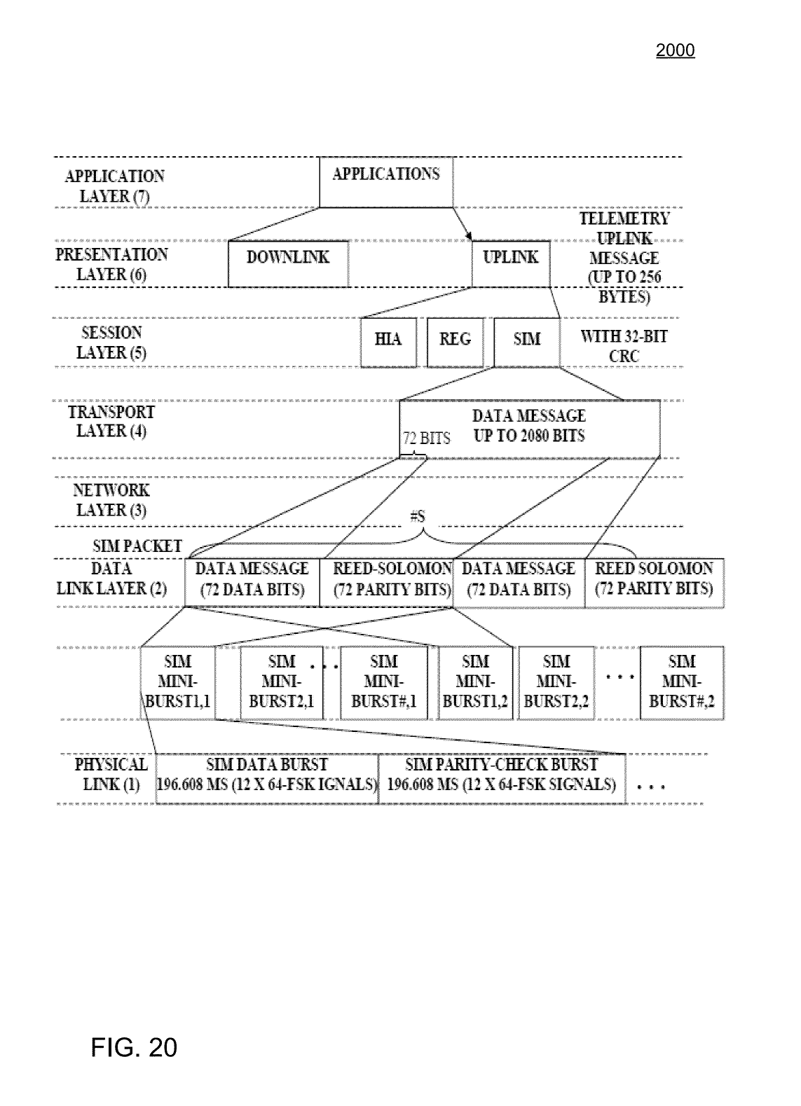

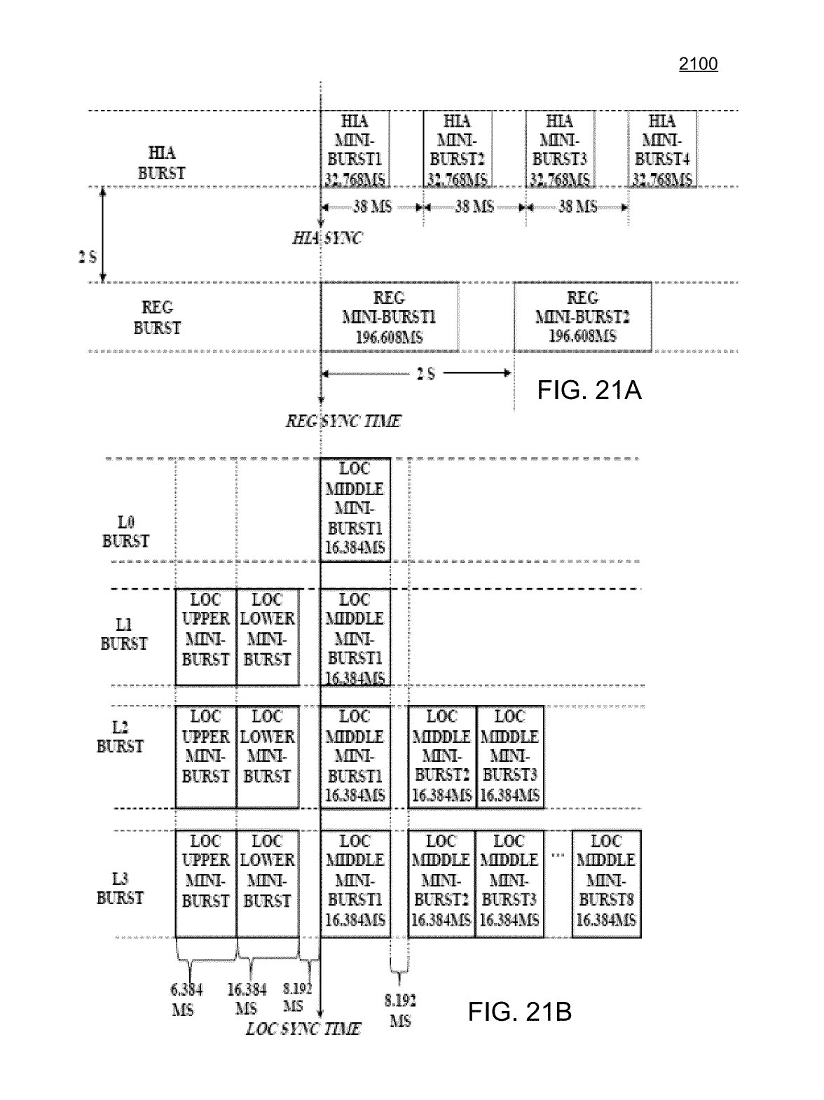

Next, each block is encoded according to Reed-Solomon coding, to form a SIM burst. Putting all the SIM bursts together shall form a SIM Packet as shown in FIG. 20.

### SIM Packet

Each SIM Packet includes of as many SIM bursts as necessary to transmit the data as shown in FIG. 20.

### SIM Burst

Each SIM burst includes of 2 SIM mini-bursts.

### LOC Transmission Timing

The Tracking application uses a LOC burst consisting of one of four locate bursts: L0 burst, L1 burst, L2 burst or L3 burst.

The transmission sequence and timing for L0 are as follows (all delays measured from start of preceding mini-burst to start of next mini-burst).

LOC Sync Time Transmit first LOC Middle mini-burst of duration 16.384 ms

The transmission sequence and timing for L1 are as follows (all delays measured from start of preceding mini-burst to start of next mini-burst).

Transmit first LOC Upper mini-burst of duration 16.384 ms

Transmit first LOC Lower mini-burst of duration 16.384 ms

delay 24.576 ms

LOC Sync Time Transmit first LOC Middle mini-burst of duration 16.384 ms

The transmission sequence and timing for L2 are as follows (all delays measured from start of preceding mini-burst to start of next mini-burst).

Transmit first LOC Upper mini-burst of duration 16.384 ms

Transmit first LOC Lower mini-burst of duration 16.384 ms

delay 24.576 ms

LOC Sync Time Transmit first LOC Middle mini-burst of duration 16.384 ms

delay 24.576 ms

Transmit second LOC Middle mini-burst of duration 16.384 ms

Transmit third LOC Middle mini-burst of duration 16.384 ms

The transmission sequence and timing for L3 are as follows (all delays measured from start of preceding mini-burst to start of next mini-burst).

Transmit first LOC Upper mini-burst of duration 16.384 ms

Transmit first LOC Lower mini-burst of duration 16.384 ms

delay 24.576 ms

Loc Sync Time Transmit first LOC Middle mini-burst of duration 16.384 ms

delay 24.576 ms

Transmit second LOC Middle mini-burst of duration 16.384 ms

Transmit third LOC Middle mini-burst of duration 16.384 ms

Transmit fourth LOC Middle mini-burst of duration 16.384 ms

Transmit fifth LOC Middle mini-burst of duration 16.384 ms

Transmit sixth LOC Middle mini-burst of duration 16.384 ms

Transmit seventh LOC Middle mini-burst of duration 16.384 ms

Transmit eighth LOC Middle mini-burst of duration 16.384 ms

### SIM Transmission Timing

The transmission sequence and timing for a SIM Packet are described as follows (all delays measured from start of preceding SIM mini-burst to start of next SIM mini-burst).

SIM Sync Time Transmit SIM mini-burst1,1 of duration 393.216 ms

delay 0.5 seconds

Transmit SIM mini-burst2,1 of duration 393.216 ms

delay 0.5 seconds

. . . continue transmission of all the SIM mini-burstsi,1 (i=3,4, . . . ,#S) and their corresponding delays

Transmit SIM mini-burst1,2 of duration 393.216 ms

delay 0.5 seconds

Transmit SIM mini-burst2,2 of duration 393.216 ms

delay 0.5 seconds

. . . continue transmission of all the SIM mini-burstsi,2 (i=3,4, . . . ,#S) and their corresponding delays

where SIM mini-burstsi,1 denotes the first SIM mini-burst of the ith SIM burst, i.e. SIM bursti, and SIM mini-burstsi,2 denotes the second SIM mini-burst of the ith SIM burst.

### Air Interface—Physical to Logical Channel Mapping

In order to increase the utilization of the bandwidth available in the 2400 MHz ISM band, the HIA, REG and SIM channels are allocated a bandwidth of 62.5 kHz each while the LOC channels are allocated a bandwidth of 250 kHz. The ISM 3 channels are allocated at a spacing of 31.25 kHz and carefully chosen to allow the channels to be interleaved. Due to the bandwidth of the HIA, REG, LOC, and SIM signals and the allowable variations in carrier frequency the HIA, REG, LOC, and SIM signals may fall outside of the allocated channels.

Some of the channels located near the 2400 MHz band edge and some of the channels located near the 2483.5 MHz band edge are left unused to serve as a guard band to assist in the compliance with the radio transmitter regulations. Leaving a 937.5 kHz guard band on the lower band edge of the 2400 MHz ISM band and a 1000 kHz guard band on the upper band edge, and designating the lowest possible RF Channel as 1, we have:

fRF=2400.9375 MHz+N(0.03125 MHz) Equation 1

Where:

N=[1, . . . ,2639] Equation 2

The distribution of these channels among the different logical channels are as follows:

12 HIA channels,

42 REG channels (paired in groups of two),

84 SIM channels (paired in groups of two),

245 LOC channels1,

123 Reserved channels.

### HIA Transmission

The 12 HIA channels have been divided into four groups of three HIA channels each. The groups are known as HIA group A, HIA group B, HIA group C, and HIA group D. The HIA channels are designated HIA channel A1, A2, A3, B1, B2, B3, C1, C2, C3, D1, D2 and D3.

When the beacon 102 transmits the four consecutive HIA mini-bursts, each one of the four HIA mini-bursts are transmitted on a different HIA channel group (either group A, B, C, or D), where the order of the groups and the channel number within the group are pseudo-randomly selected. The network base station receiver 108 network shall continuously monitor the HIA channels and shall receive the HIA mini-bursts. By decoding the Channel Sequence number within the HIA mini-burst and knowing the channel group on which the HIA mini-burst was received the Network is able to determine which of the four HIA mini-bursts was received (first, second, third or fourth). By knowing the transmission time of the HIA mini-bursts and by knowing which of the four HIA was received (first, second, third or fourth), the time of the Registration burst and the time of the Locate bursts can be determined. By decoding the Channel Sequence number within the HIA mini-burst, the channel number for each of the Registration mini-bursts can be determined. An additional 16 Locate channels are deemed unusable due to FCC emission constraints.

### HIA Channel Sequence

The HIA channels are used in such a manner that the HIA mini-bursts are uniformly distributed among the 12 HIA channels. The HIA transmission channel sequence shall conform to the following requirements.

Each HIA burst shall use one channel from each of the HIA channel groups (i.e. the four HIA mini-bursts shall use one channel from group A, one channel from group B, one channel from group C and one channel from group D).

The order in which the channel groups are used are pseudo-randomly selected and shall change from one HIA burst to the next.

The channel number within each group shall follow a pseudo-random sequence based upon the beacon 102's WIN. Each channel number of each channel group are used in any group of 3 REG (i.e. the pattern shall repeat every 12 HIA transmissions).

The CSN are initialized according to the formula given in (3.3). The Channel Sequence number (CSN) are incremented for each HIA burst by a simple linear congruent generator (LCG), which is of the format CSNi+1=(a×CSNi+b) mod 64. The LCG are assigned from the 6 LSBs of the WIN, and the initial CSN value (i.e. CSN0); or seed, are determined by Eqn. 3.3 on power-up.

The CSNNLNS are initialized according to the formula given in (3.3). The CSNNLNS are incremented for each No LOC/No SIM HIA burst by a simple linear congruent generator (LCG), which is of the format CSNi+1=(a×CSNi+b) mod 64. The beacon 102 specifications may require that certain No LOC/No SIM's use specific CSNs that may require deviations to the No LOC/No SIM CSN sequence specified in this paragraph.

CSN₀={WIN_{H}⊕[(WIN_{L}& 0x0FFF)<<1]} mod₆₄ Equation 3

Where {W/N_{H}, WIN_{L}} denote the upper and lower 16 bits of the WIN respectively, & denotes the bit-wise and operator, ⊕ denotes the bit-wise exclusive-or operator, and <<n denotes an n-bit shift to the left (i.e. multiplication by 2ⁿ).

### HIA Channel Numbers

The 12 channels reserved for HIA have been carefully chosen so as to minimize the effects of interference and to maximize system availability. The HIA channel numbers and frequencies are as follows in table 2:

TABLE 2
ISM 3 HIA Channel Pool

| | | |
|---|---|---|
| | ISM 3 | Channel |
| ISM 3 | Channel | Frequency |
| HIA Channel | Number | (MHz) |

Sorted by HIA channel designator

| | | |
|---|---|---|
| A1 | 295 | 2410.15625 |
| A2 | 1135 | 2436.40625 |
| A3 | 1765 | 2456.09375 |
| B1 | 85 | 2403.59375 |
| B2 | 505 | 2416.71875 |
| B3 | 925 | 2429.84375 |
| C1 | 1555 | 2449.53125 |
| C2 | 1975 | 2462.65625 |
| C3 | 2395 | 2475.78125 |
| D1 | 715 | 2423.28125 |
| D2 | 1345 | 2442.96875 |
| D3 | 2185 | 2469.21875 |

Sorted by channel frequency

| | | |
|---|---|---|
| B1 | 85 | 2403.59375 |
| A1 | 295 | 2410.15625 |
| B2 | 505 | 2416.71875 |
| D1 | 715 | 2423.28125 |
| B3 | 925 | 2429.84375 |
| A2 | 1135 | 2436.40625 |
| D2 | 1345 | 2442.96875 |
| C1 | 1555 | 2449.53125 |
| A3 | 1765 | 2456.09375 |
| C2 | 1975 | 2462.65625 |
| D3 | 2185 | 2469.21875 |
| C3 | 2395 | 2475.78125 |

The following relations give the carrier frequency of the HIA channels based upon the subscript index k.

f_{HIA}(Aₖ)=[77125+210×[3(k−1)+└k>>1┘]]×31250

f_{HIA}(Bₖ)=[76495+420k]×31250

f_{HIA}(Cₖ)=[77965+420k]×31250

f_{HIA}(Dₖ)=[77545+210×[4(k−1)−└k>>1┘]]×31250 Equation 4

Where └•┘ denotes integer truncation; i.e. rounding down to the nearest integer value, and >>n denotes an n-bit shift to the right (i.e. multiplication by 2-n).

### REG Transmission

When the beacon 102 transmits a REG burst, it will always transmit two identical mini-bursts. Each of the two REG are transmitted on a different REG channel. The network base station receiver 108 shall use the timing information and channel information obtained from any one of the four HIA mini-bursts to tune a portion of the Network to the specified channel at the specified time in order to receive one of the two REG. In the event that the Network fails to receive the first REG, the Network may repeat the process and attempt to receive the second REG. Each REG contains the WIN. By using the WIN and the Channel Sequence number as a seed for a pseudo-random sequence the Network is able to determine the sequence of channels that the beacon 102 will use for the LOC bursts. The timing for the LOC bursts can be derived either from the timing of the HIA.

### REG Channel Sequence

The channels used are selected such that a large number of beacons 102 102 use the REG channels in such a manner that the REG mini-bursts are uniformly distributed among the 42 REG channels. The REG transmission channel sequence shall conform to the following requirements.

Each REG mini-burst, shall use a different REG channel.

The REG channel patterns are selected based upon the CSN (or CSNNLNS), where the CSN sequence is determined by the assigned LCG.

### REG Channel Numbers

TABLE 2
ISM 3 REG Channel Pool.
The 42 channels reserved for REG have been carefully chosen
so as to minimize the effects of interference and to maximize
system availability. The REG channel numbers and
frequencies are as follows:

| ISM 3 | ISM 3 | Channel |
|---|---|---|
| REG | Channel | Frequency |
| Channel | Number | (MHz) |
| R1 | 87 | 2403.65625 |
| R2 | 147 | 2405.53125 |
| R3 | 207 | 2407.40625 |
| R4 | 267 | 2409.28125 |
| R5 | 327 | 2411.15625 |
| R6 | 387 | 2413.03125 |
| R7 | 447 | 2414.90625 |
| R8 | 507 | 2416.78125 |
| R9 | 567 | 2418.65625 |
| R10 | 627 | 2420.53125 |
| R11 | 687 | 2422.40625 |
| R12 | 747 | 2424.28125 |
| R13 | 807 | 2426.15625 |
| R14 | 867 | 2428.03125 |
| R15 | 927 | 2429.90625 |
| R16 | 987 | 2431.78125 |
| R17 | 1047 | 2433.65625 |
| R18 | 1107 | 2435.53125 |
| R19 | 1167 | 2437.40625 |
| R20 | 1227 | 2439.28125 |
| R21 | 1287 | 2441.15625 |
| R22 | 1347 | 2443.03125 |
| R23 | 1407 | 2444.90625 |
| R24 | 1467 | 2446.78125 |
| R25 | 1527 | 2448.65625 |
| R26 | 1587 | 2450.53125 |
| R27 | 1647 | 2452.40625 |
| R28 | 1707 | 2454.28125 |
| R29 | 1767 | 2456.15625 |
| R30 | 1827 | 2458.03125 |
| R31 | 1887 | 2459.90625 |
| R32 | 1947 | 2461.78125 |
| R33 | 2007 | 2463.65625 |
| R34 | 2067 | 2465.53125 |
| R35 | 2127 | 2467.40625 |
| R36 | 2187 | 2469.28125 |
| R37 | 2247 | 2471.15625 |
| R38 | 2307 | 2473.03125 |
| R39 | 2367 | 2474.90625 |
| R40 | 2427 | 2476.78125 |
| R41 | 2487 | 2478.65625 |
| R42 | 2547 | 2480.53125 |

The following equation determines the carrier frequency for the ISM 3 REG channels based upon the subscript index k of Table 2.

f_{REG}(Rₖ)=[76857+60k]×31250 Equation 5

### LOC Transmission

### LOC Channel Sequence

The network base station receiver 108 shall use the timing information and channel information obtained from either the HIA mini-bursts and from either the REG mini-bursts to tune a portion of the Network to the specified channel at the specified time in order to receive the LOC burst.

The channels used are selected such that a large number of beacons 102 102 use the LOC channels in such a manner that the LOC bursts are uniformly distributed among the LOC channels. The LOC transmission channel sequence shall conform to the requirements for unlicensed radio transmitter operation.

### LOC Channel Numbers

The 245 channels reserved for the LOC waveform have been carefully chosen so as to minimize the effects of interference and to maximize system availability. The LOC channel numbers and frequencies are provided in Table 3. Initially, 261 channels were designated, however, 21 channels shall not be used due to FCC emission constraints. i.e. ISM 3 LOC channels {0-2, 243-260}.

TABLE 3
ISM 3 LOC Channel Pool

| ISM 3 | ISM 3 | Channel |
|---|---|---|
| LOC | Channel | Frequency |
| Channel | Number | (MHz) |
| L0 | 8 | 2401.18750 |
| L1 | 12 | 2401.31250 |
| L2 | 16 | 2401.43750 |
| L3 | 38 | 2402.12500 |
| L4 | 42 | 2402.25000 |
| L5 | 46 | 2402.37500 |
| L6 | 68 | 2403.06250 |
| L7 | 72 | 2403.18750 |
| L8 | 76 | 2403.31250 |
| L9 | 98 | 2404.00000 |
| L10 | 102 | 2404.12500 |
| L11 | 106 | 2404.25000 |
| L12 | 128 | 2404.93750 |
| L13 | 132 | 2405.06250 |
| L14 | 136 | 2405.18750 |
| L15 | 158 | 2405.87500 |
| L16 | 162 | 2406.00000 |
| L17 | 166 | 2406.12500 |
| L18 | 188 | 2406.81250 |
| L19 | 192 | 2406.93750 |
| L20 | 196 | 2407.06250 |
| L21 | 218 | 2407.75000 |
| L22 | 222 | 2407.87500 |
| L23 | 226 | 2408.00000 |
| L24 | 248 | 2408.68750 |
| L25 | 252 | 2408.81250 |
| L26 | 256 | 2408.93750 |
| L27 | 278 | 2409.62500 |
| L28 | 282 | 2409.75000 |
| L29 | 286 | 2409.87500 |
| L30 | 308 | 2410.56250 |
| L31 | 312 | 2410.68750 |
| L32 | 316 | 2410.81250 |
| L33 | 338 | 2411.50000 |
| L34 | 342 | 2411.62500 |
| L35 | 346 | 2411.75000 |
| L36 | 368 | 2412.43750 |
| L37 | 372 | 2412.56250 |
| L38 | 376 | 2412.68750 |
| L39 | 398 | 2413.37500 |
| L40 | 402 | 2413.50000 |
| L41 | 406 | 2413.62500 |
| L42 | 428 | 2414.31250 |
| L43 | 432 | 2414.43750 |
| L44 | 436 | 2414.56250 |
| L45 | 458 | 2415.25000 |
| L46 | 462 | 2415.37500 |
| L47 | 466 | 2415.50000 |
| L48 | 488 | 2416.18750 |
| L49 | 492 | 2416.31250 |
| L50 | 496 | 2416.43750 |
| L51 | 518 | 2417.12500 |
| L52 | 522 | 2417.25000 |
| L53 | 526 | 2417.37500 |
| L54 | 548 | 2418.06250 |
| L55 | 552 | 2418.18750 |
| L56 | 556 | 2418.31250 |
| L57 | 578 | 2419.00000 |
| L58 | 582 | 2419.12500 |
| L59 | 586 | 2419.25000 |
| L60 | 608 | 2419.93750 |
| L61 | 612 | 2420.06250 |
| L62 | 616 | 2420.18750 |
| L63 | 638 | 2420.87500 |
| L64 | 642 | 2421.00000 |
| L65 | 646 | 2421.12500 |
| L66 | 668 | 2421.81250 |
| L67 | 672 | 2421.93750 |
| L68 | 676 | 2422.06250 |
| L69 | 698 | 2422.75000 |
| L70 | 702 | 2422.87500 |
| L71 | 706 | 2423.00000 |
| L72 | 728 | 2423.68750 |
| L73 | 732 | 2423.81250 |
| L74 | 736 | 2423.93750 |
| L75 | 758 | 2424.62500 |
| L76 | 762 | 2424.75000 |
| L77 | 766 | 2424.87500 |
| L78 | 788 | 2425.56250 |
| L79 | 792 | 2425.68750 |
| L80 | 796 | 2425.81250 |
| L81 | 818 | 2426.50000 |
| L82 | 822 | 2426.62500 |
| L83 | 826 | 2426.75000 |
| L84 | 848 | 2427.43750 |
| L85 | 852 | 2427.56250 |
| L86 | 856 | 2427.68750 |
| L87 | 878 | 2428.37500 |
| L88 | 882 | 2428.50000 |
| L89 | 886 | 2428.62500 |
| L90 | 908 | 2429.31250 |
| L91 | 912 | 2429.43750 |
| L92 | 916 | 2429.56250 |
| L93 | 938 | 2430.25000 |
| L94 | 942 | 2430.37500 |
| L95 | 946 | 2430.50000 |
| L96 | 968 | 2431.18750 |
| L97 | 972 | 2431.31250 |
| L98 | 976 | 2431.43750 |
| L99 | 998 | 2432.12500 |
| L100 | 1002 | 2432.25000 |
| L101 | 1006 | 2432.37500 |
| L102 | 1028 | 2433.06250 |
| L103 | 1032 | 2433.18750 |
| L104 | 1036 | 2433.31250 |
| L105 | 1058 | 2434.00000 |
| L106 | 1062 | 2434.12500 |
| L107 | 1066 | 2434.25000 |
| L108 | 1088 | 2434.93750 |
| L109 | 1092 | 2435.06250 |
| L110 | 1096 | 2435.18750 |
| L111 | 1118 | 2435.87500 |
| L112 | 1122 | 2436.00000 |
| L113 | 1126 | 2436.12500 |
| L114 | 1148 | 2436.81250 |
| L115 | 1152 | 2436.93750 |
| L116 | 1156 | 2437.06250 |
| L117 | 1178 | 2437.75000 |
| L118 | 1182 | 2437.87500 |
| L119 | 1186 | 2438.00000 |
| L120 | 1208 | 2438.68750 |
| L121 | 1212 | 2438.81250 |
| L122 | 1216 | 2438.93750 |
| L123 | 1238 | 2439.62500 |
| L124 | 1242 | 2439.75000 |
| L125 | 1246 | 2439.87500 |
| L126 | 1268 | 2440.56250 |
| L127 | 1272 | 2440.68750 |
| L128 | 1276 | 2440.81250 |
| L129 | 1298 | 2441.50000 |
| L130 | 1302 | 2441.62500 |
| L131 | 1306 | 2441.75000 |
| L132 | 1328 | 2442.43750 |
| L133 | 1332 | 2442.56250 |
| L134 | 1336 | 2442.68750 |
| L135 | 1358 | 2443.37500 |
| L136 | 1362 | 2443.50000 |
| L137 | 1366 | 2443.62500 |
| L138 | 1388 | 2444.31250 |
| L139 | 1392 | 2444.43750 |
| L140 | 1396 | 2444.56250 |
| L141 | 1418 | 2445.25000 |
| L142 | 1422 | 2445.37500 |
| L143 | 1426 | 2445.50000 |
| L144 | 1448 | 2446.18750 |
| L145 | 1452 | 2446.31250 |
| L146 | 1456 | 2446.43750 |
| L147 | 1478 | 2447.12500 |
| L148 | 1482 | 2447.25000 |
| L149 | 1486 | 2447.37500 |
| L150 | 1508 | 2448.06250 |
| L151 | 1512 | 2448.18750 |
| L152 | 1516 | 2448.31250 |
| L153 | 1538 | 2449.00000 |
| L154 | 1542 | 2449.12500 |
| L155 | 1546 | 2449.25000 |
| L156 | 1568 | 2449.93750 |
| L157 | 1572 | 2450.06250 |
| L158 | 1576 | 2450.18750 |
| L159 | 1598 | 2450.87500 |
| L160 | 1602 | 2451.00000 |
| L161 | 1606 | 2451.12500 |
| L162 | 1628 | 2451.81250 |
| L163 | 1632 | 2451.93750 |
| L164 | 1636 | 2452.06250 |
| L165 | 1658 | 2452.75000 |
| L166 | 1662 | 2452.87500 |
| L167 | 1666 | 2453.00000 |
| L168 | 1688 | 2453.68750 |
| L169 | 1692 | 2453.81250 |
| L170 | 1696 | 2453.93750 |
| L171 | 1718 | 2454.62500 |
| L172 | 1722 | 2454.75000 |
| L173 | 1726 | 2454.87500 |
| L174 | 1748 | 2455.56250 |
| L175 | 1752 | 2455.68750 |
| L176 | 1756 | 2455.81250 |
| L177 | 1778 | 2456.50000 |
| L178 | 1782 | 2456.62500 |
| L179 | 1786 | 2456.75000 |
| L180 | 1808 | 2457.43750 |
| L181 | 1812 | 2457.56250 |
| L182 | 1816 | 2457.68750 |
| L183 | 1838 | 2458.37500 |
| L184 | 1842 | 2458.50000 |
| L185 | 1846 | 2458.62500 |
| L186 | 1868 | 2459.31250 |
| L187 | 1872 | 2459.43750 |
| L188 | 1876 | 2459.56250 |
| L189 | 1898 | 2460.25000 |
| L190 | 1902 | 2460.37500 |
| L191 | 1906 | 2460.50000 |
| L192 | 1928 | 2461.18750 |
| L193 | 1932 | 2461.31250 |
| L194 | 1936 | 2461.43750 |
| L195 | 1958 | 2462.12500 |
| L196 | 1962 | 2462.25000 |
| L197 | 1966 | 2462.37500 |
| L198 | 1988 | 2463.06250 |
| L199 | 1992 | 2463.18750 |
| L200 | 1996 | 2463.31250 |
| L201 | 2018 | 2464.00000 |
| L202 | 2022 | 2464.12500 |
| L203 | 2026 | 2464.25000 |
| L204 | 2048 | 2464.93750 |
| L205 | 2052 | 2465.06250 |
| L206 | 2056 | 2465.18750 |
| L207 | 2078 | 2465.87500 |
| L208 | 2082 | 2466.00000 |
| L209 | 2086 | 2466.12500 |
| L210 | 2108 | 2466.81250 |
| L211 | 2112 | 2466.93750 |
| L212 | 2116 | 2467.06250 |
| L213 | 2138 | 2467.75000 |
| L214 | 2142 | 2467.87500 |
| L215 | 2146 | 2468.00000 |
| L216 | 2168 | 2468.68750 |
| L217 | 2172 | 2468.81250 |
| L218 | 2176 | 2468.93750 |
| L219 | 2198 | 2469.62500 |
| L220 | 2202 | 2469.75000 |
| L221 | 2206 | 2469.87500 |
| L222 | 2228 | 2470.56250 |
| L223 | 2232 | 2470.68750 |
| L224 | 2236 | 2470.81250 |
| L225 | 2258 | 2471.50000 |
| L226 | 2262 | 2471.62500 |
| L227 | 2266 | 2471.75000 |
| L228 | 2288 | 2472.43750 |
| L229 | 2292 | 2472.56250 |
| L230 | 2296 | 2472.68750 |
| L231 | 2318 | 2473.37500 |
| L232 | 2322 | 2473.50000 |
| L233 | 2326 | 2473.62500 |
| L234 | 2348 | 2474.31250 |
| L235 | 2352 | 2474.43750 |
| L236 | 2356 | 2474.56250 |
| L237 | 2378 | 2475.25000 |
| L238 | 2382 | 2475.37500 |
| L239 | 2386 | 2475.50000 |
| L240 | 2408 | 2476.18750 |
| L241 | 2412 | 2476.31250 |
| L242 | 2416 | 2476.43750 |
| L243 | 2438 | 2477.12500 |
| L244 | 2442 | 2477.25000 |
| L245 | 2446 | 2477.37500 |
| L246 | 2468 | 2478.06250 |
| L247 | 2472 | 2478.18750 |
| L248 | 2476 | 2478.31250 |
| L249 | 2498 | 2479.00000 |
| L250 | 2502 | 2479.12500 |
| L251 | 2506 | 2479.25000 |
| L252 | 2528 | 2479.93750 |
| L253 | 2532 | 2480.06250 |
| L254 | 2536 | 2480.18750 |
| L255 | 2558 | 2480.87500 |
| L256 | 2562 | 2481.00000 |
| L257 | 2566 | 2481.12500 |
| L258 | 2588 | 2481.81250 |
| L259 | 2592 | 2481.93750 |
| L260 | 2596 | 2482.06250 |

The following equation determines the carrier frequency for the ISM 3 LOC channels based upon the subscript index k of the Table 4, i.e. ISM 3 LOC Channel column of Table 4.

TABLE 4
${f}_{LOC} ( {L}_{k} ) = \{ \begin{matrix}[ 76838 + 10 k ] \times 31250 , & for k mod 3 = 0 \\ [ 76832 + 10 k ] \times 31250 , & for k mod 3 = 1 \\ [ 76826 + 10 k ] \times 31250 , & for k mod 3 = 2\end{matrix}$

The modulus of the index k (i.e. k modulo 3 or k mod 3) may be determined by division or by iterative reduction, i.e. subtracting the modulus until k<3. The division approach may not be viable if the beacon 102's microprocessor does not support division, and the iterative step decrement is not efficient. It is desirable to have a rapid and efficient method to determine the modulus such that critical timing intervals maintained by the beacon 102 are not jeopardized. It is possible to reduce the number of iterations required by using the following property (i.e. Mersenne numbers).

k mod(2ⁿ−1)=(k mod 2ⁿ+k>>n)mod(2ⁿ−1). Equation 6

Therefore, to obtain k mod 3 we have

$$\begin{matrix}k mod 3 = ( k mod {2}^{2} + k >> 2 ) mod ( {2}^{2} - 1 ) \\ = ( k \& 0 \times 0003 + k >> 2 ) mod 3 ,\end{matrix} \qquad Equation 7$$

where & denotes the bit-wise and operator.

If the right hand side (rhs) of Eqn 7; i.e. (k & 0x0003+k>>2), yields a result ≧22-1 then one has to perform iterative reduction (i.e. subtracting 22−1=3). Since k spans [1, . . . , 245]; implying that the rhs of Eqn 7 spans [0, . . . , 62], significant iterative reduction can still occur. However, one can iteratively apply Eqn. 3.8 to each resulting rhs to perform the reduction.

For example, let k=245=0x00F5, which we know 245 mod 3=2. Applying Eqn. 3.8 iteratively, we obtain the following.

245 mod 3=(0x00F5 & 0x0003+245>>2)mod 3

=62 mod 3

62 mod 3=(0x003E & 0x0003+62>>2)mod 3

=17 mod 3

17 mod 3=(0x0011 & 0x0003+17>>2)mod 3

=5 mod 3

5 mod 3=(0x0005 & 0x0003+5>>2)mod 3

=2 mod 3

245 mod 3=

Note that if applying this method and the rhs=3, iterative reduction by using Eqn. 3.8 can result in an infinite loop since (3 & 0x0003+3>>2)=3

### SIM Channel Sequence

The channels used are selected such that a large number of beacons 102 102 use the SIM channels in such a manner that the SIM mini-bursts are uniformly distributed among the SIM channels. The SIM transmission channel sequence shall conform to the requirements for unlicensed radio transmitter operation.

### SIM Channel Numbers

There are 84 channels for use by SIM. These channels have been chosen so as to reduce the effects of interference and to improve system availability. The channels used by SIM are listed in Table 5.

The following equation determines the carrier frequency for the ISM 3 SIM channels based upon the subscript index k of the Table 5.

TABLE 5
ISM 3 SIM Channel Pool
f_{SIM} (Mₖ) = [76889 + 30k] × 31250

| ISM 3 | ISM 3 | Channel |
|---|---|---|
| SIM | Channel | Frequency |
| Channel | Number | (MHz) |
| M1 | 89 | 2403.71875 |
| M2 | 119 | 2404.65625 |
| M3 | 149 | 2405.59375 |
| M4 | 179 | 2406.53125 |
| M5 | 209 | 2407.46875 |
| M6 | 239 | 2408.40625 |
| M7 | 269 | 2409.34375 |
| M8 | 299 | 2410.28125 |
| M9 | 329 | 2411.21875 |
| M10 | 359 | 2412.15625 |
| M11 | 389 | 2413.09375 |
| M12 | 419 | 2414.03125 |
| M13 | 449 | 2414.96875 |
| M14 | 479 | 2415.90625 |
| M15 | 509 | 2416.84375 |
| M16 | 539 | 2417.78125 |
| M17 | 569 | 2418.71875 |
| M18 | 599 | 2419.65625 |
| M19 | 629 | 2420.59375 |
| M20 | 659 | 2421.53125 |
| M21 | 689 | 2422.46875 |
| M22 | 719 | 2423.40625 |
| M23 | 749 | 2424.34375 |
| M24 | 779 | 2425.28125 |
| M25 | 809 | 2426.21875 |
| M26 | 839 | 2427.15625 |
| M27 | 869 | 2428.09375 |
| M28 | 899 | 2429.03125 |
| M29 | 929 | 2429.96875 |
| M30 | 959 | 2430.90625 |
| M31 | 989 | 2431.84375 |
| M32 | 1019 | 2432.78125 |
| M33 | 1049 | 2433.71875 |
| M34 | 1079 | 2434.65625 |
| M35 | 1109 | 2435.59375 |
| M36 | 1139 | 2436.53125 |
| M37 | 1169 | 2437.46875 |
| M38 | 1199 | 2438.40625 |
| M39 | 1229 | 2439.34375 |
| M40 | 1259 | 2440.28125 |
| M41 | 1289 | 2441.21875 |
| M42 | 1319 | 2442.15625 |
| M43 | 1349 | 2443.09375 |
| M44 | 1379 | 2444.03125 |
| M45 | 1409 | 2444.96875 |
| M46 | 1439 | 2445.90625 |
| M47 | 1469 | 2446.84375 |
| M48 | 1499 | 2447.78125 |
| M49 | 1529 | 2448.71875 |
| M50 | 1559 | 2449.65625 |
| M51 | 1589 | 2450.59375 |
| M52 | 1619 | 2451.53125 |
| M53 | 1649 | 2452.46875 |
| M54 | 1679 | 2453.40625 |
| M55 | 1709 | 2454.34375 |
| M56 | 1739 | 2455.28125 |
| M57 | 1769 | 2456.21875 |
| M58 | 1799 | 2457.15625 |
| M59 | 1829 | 2458.09375 |
| M60 | 1859 | 2459.03125 |
| M61 | 1889 | 2459.96875 |
| M62 | 1919 | 2460.90625 |
| M63 | 1949 | 2461.84375 |
| M64 | 1979 | 2462.78125 |
| M65 | 2009 | 2463.71875 |
| M66 | 2039 | 2464.65625 |
| M67 | 2069 | 2465.59375 |
| M68 | 2099 | 2466.53125 |
| M69 | 2129 | 2467.46875 |
| M70 | 2159 | 2468.40625 |
| M71 | 2189 | 2469.34375 |
| M72 | 2219 | 2470.28125 |
| M73 | 2249 | 2471.21875 |
| M74 | 2279 | 2472.15625 |
| M75 | 2309 | 2473.09375 |
| M76 | 2339 | 2474.03125 |
| M77 | 2369 | 2474.96875 |
| M78 | 2399 | 2475.90625 |
| M79 | 2429 | 2476.84375 |
| M80 | 2459 | 2477.78125 |
| M81 | 2489 | 2478.71875 |
| M82 | 2519 | 2479.65625 |
| M83 | 2549 | 2480.59375 |
| M84 | 2579 | 2481.53125 |

### HIA Mini-Burst Frequency Hopping Pattern

The sub-channels in the HIA groupings {A, B, C, D} have a period of three, which ensures that each of the frequencies of each individual sub-group is transmitted in any three consecutive REG periods. This restricts the randomness of the selection of sub-channels selected per group in any time interval. i.e.

$$( \begin{matrix}3 \\ 1\end{matrix} )$$

per group {A, B, C, D} in the first registration interval, then

$$( \begin{matrix}2 \\ 1\end{matrix} )$$

for the second interval, and

$$( \begin{matrix}1 \\ 1\end{matrix} )$$

for the third interval.

For example, for HIA group A, we can start from the set {1, 2, 3}. If 3 is selected for the first interval, then on the next interval we are restricted to the set {1, 2} for HIA A. If 1 is then selected, then for the third interval we must use 2 for HIA A. Thus, the HIA A pattern becomes {A3, A1, A2}.

The HIA grouping pattern based on the CSN shall follow that outlined in Table 6, which contains the HIA and REG channel sequences for the corresponding Channel Sequence number.

The HIA sub-channel selection can only generate two possible sequences, i.e. {1, 2, 3, 1, . . . } and {1, 3, 2, 1, . . . }. Therefore, sequence {1, 2, 3, . . . } and {1, 3, 2, . . . } are denoted as HIA sub-sequence 0 and 1 respectively.

For HIA groups {A, B, C, D}, the corresponding sub-sequence are determined by bits {W(9), W(10), W(11), W(12)} of the 32-bit WIN, where W(0) represents the least significant bit (LSB) of the WIN. The HIA sub-sequences can easily be generated in the following manner.

$${y}_{k + 1} + 1 = \{ \begin{matrix}( {y}_{k} + 1 ) {mod}_{3} + 1 , & for WIN {bit}_{i} = 0 \\ ( {y}_{k} + 2 ) {mod}_{3} + 1 , & for WIN {bit}_{i} = 1\end{matrix}$$

The initial or starting seed for each HIA sequence are determined upon power-up of the beacon 102, where the 8 LSBs are paired in the following method.

$${y}_{0} + 1 = \{ \begin{matrix}[ W ( 1 ) W ( 0 ) ] {mod}_{3} + 1 , & for HIA group A \\ [ W ( 3 ) W ( 2 ) ] {mod}_{3} + 1 , & for HIA group B \\ [ W ( 5 ) W ( 4 ) ] {mod}_{3} + 1 , & for HIA group C \\ [ W ( 7 ) W ( 6 ) ] {mod}_{3} + 1 , & for HIA group D\end{matrix}$$

For example, let WIN=5695785=0x0056 E929.

The 8 LSBs of the WIN are b#0010 1001, thus, the initial seed of the HIA groups {A, B, C, D} are y0+1={2, 3, 3, 1} respectively. Similarly, {W(9), W(10), W(11), W(12)}={0, 0, 1, 0}. Therefore, HIA groups {A, B, C, D} will use sub-sequences {0, 0, 1, 0} respectively.

Thus, the consecutive sub channel numbering per HIA group upon power-up is then as follows:

| k | Aₖ | Bₖ | Cₖ | Dₖ |
|---|---|---|---|---|
| 0 | 2 | 3 | 3 | 1 |
| 1 | 3 | 1 | 2 | 2 |
| 2 | 1 | 2 | 1 | 3 |
| 3 | 2 | 3 | 3 | 1 |
| 4 | 3 | 1 | 2 | 2 |

### REG Channel Frequency Hopping Pattern

TABLE 6
Logical Channel Sequence.

| | HIA | |
|---|---|---|
| CSN | Group | REG |
| 0x00 | A, B, C, D | R1, R8 |
| 0x01 | A, B, D, C | R2, R9 |
| 0x02 | A, C, B, D | R3, R10 |
| 0x03 | A, C, D, B | R4, R11 |
| 0x04 | A, D, B, C | R5, R12 |
| 0x05 | A, D, C, B | R6, R13 |
| 0x06 | B, A, C, D | R7, R14 |
| 0x07 | B, A, D, C | R8, R15 |
| 0x08 | B, C, A, D | R9, R16 |
| 0x09 | B, C, D, A | R10, R17 |
| 0x0A | B, D, A, C | R11, R18 |
| 0x0B | B, D, C, A | R12, R19 |
| 0x0C | C, A, B, D | R13, R20 |
| 0x0D | C, A, D, B | R14, R21 |
| 0x0E | C, B, A, D | R15, R22 |
| 0x0F | C, B, D, A | R16, R23 |
| 0x10 | C, D, A, B | R17, R24 |
| 0x11 | C, D, B, A | R18, R25 |
| 0x12 | D, A, B, C | R19, R26 |
| 0x13 | D, A, C, B | R20, R27 |
| 0x14 | D, B, A, C | R21, R28 |
| 0x15 | D, B, C, A | R22, R29 |
| 0x16 | D, C, A, B | R23, R30 |
| 0x17 | D, C, B, A | R24, R31 |
| 0x18 | A, B, C, D | R25, R32 |
| 0x19 | A, B, D, C | R26, R33 |
| 0x1A | A, C, B, D | R27, R34 |
| 0x1B | A, C, D, B | R28, R35 |
| 0x1C | A, D, B, C | R29, R36 |
| 0x1D | A, D, C, B | R30, R37 |
| 0x0E | B, A, C, D | R31, R38 |
| 0x1F | B, A, D, C | R32, R39 |
| 0x20 | B, C, A, D | R33, R40 |
| 0x21 | B, C, D, A | R34, R41 |
| 0x22 | B, D, A, C | R35, R42 |
| 0x23 | B, D, C, A | R36, R1 |
| 0x24 | C, A, B, D | R37, R2 |
| 0x25 | C, A, D, B | R38, R3 |
| 0x26 | C, B, A, D | R39, R4 |
| 0x27 | C, B, D, A | R40, R5 |
| 0x28 | C, D, A, B | R41, R6 |
| 0x29 | C, D, B, A | R42, R7 |
| 0x2A | D, A, B, C | R15, R28 |
| 0x2B | D, A, C, B | R16, R29 |
| 0x2C | D, B, A, C | R17, R30 |
| 0x2D | D, B, C, A | R18, R31 |
| 0x2E | D, C, A, B | R19, R32 |
| 0x2F | D, C, B, A | R20, R33 |
| 0x30 | A, B, C, D | R21, R34 |
| 0x31 | A, B, D, C | R22, R35 |
| 0x32 | A, C, B, D | R23, R36 |
| 0x33 | A, C, D, B | R24, R37 |
| 0x34 | A, D, B, C | R25, R38 |
| 0x35 | A, D, C, B | R26, R39 |
| 0x36 | B, A, C, D | R27, R40 |
| 0x37 | B, A, D, C | R28, R41 |
| 0x38 | B, C, A, D | R29, R42 |
| 0x39 | B, C, D, A | R30, R1 |
| 0x3A | B, D, A, C | R31, R2 |
| 0x3B | B, D, C, A | R32, R3 |
| 0x3C | C, A, B, D | R33, R4 |
| 0x3D | C, A, D, B | R34, R5 |
| 0x3E | C, B, A, D | R35, R6 |
| 0x3F | C, B, D, A | R36, R7 |

Table 6 can be partitioned into two regions, where the REG channel pairs {RX,RY} are easily determined by the following relationships.

$$If CSN \leq 0 \times 29 ( or 41 decimal )$$

$$X = CSN + 1$$

$$Y = \{ \begin{matrix}X + 7 , & if Y \leq 42 \\ ( X + 13 ) - 42 , & otherwise ,\end{matrix} \\ else \\ X = CSN - 27 \\ Y = \{ \begin{matrix}X + 13 , & if Y \leq 42 \\ ( X + 13 ) - 42 , & otherwise ,\end{matrix}$$

For example, if CSN=0x2D=45, then X=(45-27)=18, and Y=18+13=31.

Thus, the corresponding REG channel pair is {RX,RY}={R18,R31}.

### LOC Channel Frequency Hopping Pattern

The selection of channels is both uniform and reproducible. Uniform specifies that all resources (i.e. all available channels) residing in the designated channel pool are used equally on average. This is required in order to minimize collisions, where collisions are contention of the same RF channel frequency by more than one user. Although there is inherently some time diversity in the system, where the probability of multiple users occupying the same RF channel frequency is low, however, as the number of users increase then the probability of collisions will increase.

Reproducible specifies that both the ISM 3 beacon 102 (including future versions) and the ISM 3 receivers (via the Network) can both reproduce the ordered selection of resources from common information known to both.

Using an n-bit linear feedback shift register (LFSR) implementation of a M-sequence; which guarantees a period of 2n−1, provides a viable method for selecting the hop pattern of LOC transmission sequences. Thus, one can select a suitable PN sequence with a long cyclic period; however, the number of resources N (i.e. number of available channels dedicated to LOC transmissions) either directly or indirectly restricts the period. For example, one can take m consecutive clocked bits of the output sequence to select the resources, where N≦2m. However, the sub-sequences of the long M-sequence do not guarantee a period of 2n−1.

In order to maintain a unique code phase of the M-sequence for every beacon 102, the 32-bit WIN and 6-bit CSN are used as the initial state for the LFSR. This implies that we require 38-degree primitive polynomial to implement as a LFSR. Implementing a 38-degree polynomial is feasible on the beacon 102's 16-bit microprocessor. The primitive polynomial f(x)=x38+x6+x5+x+1 are used.

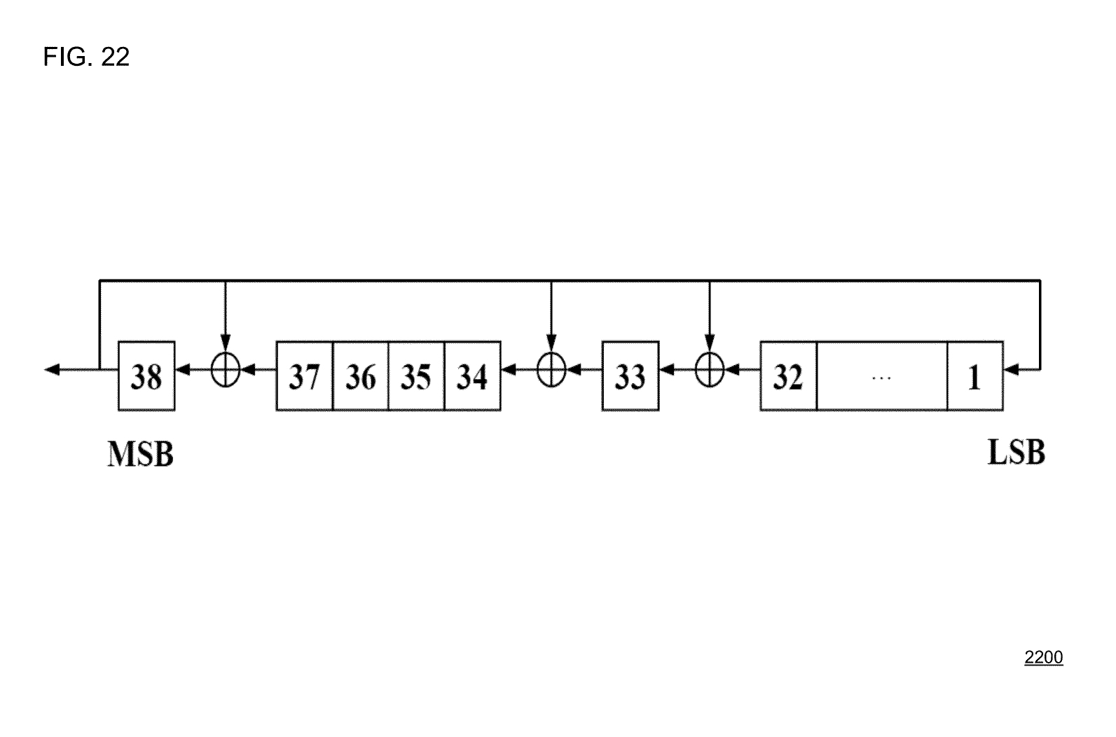

It should be noted that there are two possible LFSR configurations, Fibonacci and Galois. The Fibonacci configuration is suitable for gate implementation in hardware devices (i.e. programmable logic devices), while the Galois configuration is well suited for software implementation. Galois configuration is illustrated in FIG. 22, where ⊕ denotes the bit-wise exclusive-or operator.

For the Galois configuration, the reciprocal polynomial f*(x)=x38+x37+x33+x32+1 are implemented.

There are 245; i.e. [1, . . . , 245], usable LOC channels. When the mini-burst feature is enabled; which has consecutive LOC transmissions spaced at ±937.5 kHz of the previous designated LOC channel, the resources become further restricted to Locate channels [3, . . . , 242] due to the FCC emission constraints. This requires an 8-bit mask, with extra conditional checks to determine if the generated channel is valid (i.e. 3≦channel≦242). Thus, rather than collecting 8 consecutive clocked output MSBs of the LFSR to generate a possible LOC channel, the same generated value can be obtained from the 8 LSBs of the state register of the Galois configuration.

If the generated LOC channel is deemed invalid, then the state register must be clocked an additional 8 times per generated channel. Unfortunately, this adds some processing cycle uncertainty, since every generated channel requires validity checks and the process continues until a valid channel is generated.

Therefore, the LOC channel sequence generation is as follows:

The LFSR spans three 16-bit words, where a single clock/shift of the LFSR can be accomplished in a similar manner as the pseudo code provided below.

| | |
|---|---|
| a. | Let LFSR := [FSR2, LFSR1, LFSRO0], where LFSRi denotes a 16-bit portion of the |

overall 38 bit state register. It may be noted that only the 6 LSBs of LFSR2 are

| | |
|---|---|
| utilized. | |
| b. | Also, let BitMask := [BitMask2, BitMask1, BitMask0], which indicates the |

feedback tap connections/coefficients of the state register.

| | |
|---|---|
| c. | The coefficients are BitMask = 0x11 8000 0000, therefore, [BitMask2, |

BitMask1, BitMask0] = [0x0011, 0x8000, 0x0000] respectively.

| | | |
|---|---|---|
| d. | bit MSB = (LFSR2 >> 5) & 0x0001 | /* mask off MSB of 38-bit state |

register */

| | | |
|---|---|---|
| e. | if bit MSB > 0 | |
| f. | { | |
| g. | LFSR2 = LFSR2 & BitMask2 | |
| h. | LFSR1 = LFSR1 & BitMask1 | |
| i. | } | |
| j. | temp = (LFSR0 >> 15) & 0x0001 | /* determine MSB for LFSR1 LSB */ |
| k. | LFSR0 = (LFSR0 << 1) ⊕ bit MSB | /* LFSR0 has now been updated */ |
| l. | bit MSB = (LFSR1 >> 15) & 0x0001 | /* determine MSB for LFSR2 LSB */ |
| m. | LFSR1 = (LFSR1 << 1) ⊕ temp | /* LFSR1 has now been updated */ |
| n. | LFSR2 = (LFSR2 << 1) ⊕ bit MSB | /* LFSR2 has now been updated */ |
| o. | LFSR2 = LFSR2 & 0x003F | /* mask off 6 LSBs of LFSR2 */ |

It should be noted that this hop function is not sophisticated, especially if one is a cryptanalyst. This function was chosen for its implementation ease in the beacon 102 and its uniformity of resource selection.

For example, let CSN=61=0x3D for the current Registration period, and WIN=5695785=0x0056 E929.

Therefore, the initial seed of the LFSR state register is

LFSR=[00000000010101101110100100101001111101],=0x00 15BA 4A7D

and after 38 clocks (to ensure some randomization of initial seed) we have

LFSR=[11001000011001111000110110100011101110]≦0x32 19E3 68EE.

If we now generate 20 consecutive LOC channels, i.e. k=[1, 2, . . . , 20], for a REG period; neglecting two LOC mini-bursts, we obtain the following.

| | ISM 3 | Channel | | ISM 3 | Channel |
|---|---|---|---|---|---|
| | LOC | Frequency | | LOC | Frequency |
| K | Channel | (MHz)) | k | Channel | (MHz) |
| 1 | 139 | 2444.43750 | 11 | 102 | 2433.06250 |
| 2 | 229 | 2472.56250 | 12 | 86 | 2427.68750 |
| 3 | 216 | 2468.68750 | 13 | 39 | 2413.37500 |
| 4 | 2 | Invalid | 14 | 108 | 2434.93750 |
| 4 | 197 | 2462.37500 | 15 | 22 | 2407.87500 |
| 5 | 229 | 2472.56250 | 16 | 92 | 2429.56250 |
| 6 | 203 | 2464.25000 | 17 | 139 | 2444.43750 |
| 7 | 224 | 2470.81250 | 18 | 76 | 2424.75000 |
| 8 | 245 | Invalid | 19 | 186 | 2459.31250 |
| 8 | 183 | 2458.37500 | 20 | 67 | 2421.93750 |
| 9 | 95 | 2430.50000 | | | |

It may be noted that LOC channels 229 and 139 were both repeated once, and the maximum number of possible channels generated per valid channel is two in this instance.

### SIM Channel Frequency Hopping Pattern

An LFSR implementation of a ML-sequence which ensures a uniform selection of all the SIM channels, similar to the one used to generate the LOC channels frequency hopping pattern, are used. The LFSR shall use the generator polynomial

f*(x)=x38+x37+x33+x32+1

to generate the SIM channel hop pattern. The 32-bit WIN and 6-bit CSN are used as the initial state for the LFSR, i.e. LFSR0=[(WIN<<6) ⊕ CSN clocked 38 times]. FIG. 7 shows the specified LFSR with Galois configuration.

The LFSR are clocked 6 times to generate an index (less than 64) called “SIM burst channel index” for selecting a pair of SIM channels to be utilized by SIM mini-burst1 and SIM mini-burst2. That index are obtained only by considering the 6 LSB's of the state register of the Galois configuration which is well suited for software development of LFSR's.

As an example, let CSN=61=0x3D and WIN=123456789=0x075BCD15.

Therefore, the SIM LFER state register is preloaded as

LFSR=[00,0001,1101,0110,1111,0011,0100,0101,0111,1101]b,

And the initial seed of the SIM LFSR state register (after 38 clocks) is

LFSR=[10,0100,0110,1111,1101,1100,1001,1101,0100,0011]b=0x24 6FDC 9D43.

When 32 consecutive SIM burst channel indices, i.e. k=[1, 2, . . . , 32] are generated, to be used by SIM bursts which belong to a SIM Packet, obtain the SIM burst channel indices listed in Table 7:

TABLE 7
SIM burst channel index generated for WIN = 123456789 and CSN = 61

| | SIM burst |
|---|---|
| | channel |
| k | index |
| 1 | 33 |
| 2 | 8 |
| 3 | 6 |
| 4 | 19 |
| 5 | 10 |
| 6 | 15 |
| 7 | 11 |
| 8 | 35 |
| 9 | 4 |
| 10 | 31 |
| 11 | 34 |
| 12 | 24 |
| 13 | 31 |
| 14 | 22 |
| 15 | 3 |
| 16 | 2 |
| 17 | 1 |
| 18 | 17 |
| 19 | 19 |
| 20 | 39 |
| 21 | 32 |
| 22 | 38 |
| 23 | 36 |
| 24 | 13 |
| 25 | 8 |
| 26 | 13 |
| 27 | 20 |
| 28 | 36 |
| 29 | 10 |
| 30 | 8 |
| 31 | 26 |
| 32 | 9 |

The SIM channels used by the two SIM mini-bursts which belong to the same SIM burst are separated in frequency to reduce fades and interference. There are 84 SIM channels that are paired in an order such that paired channels shall not repeat (i.e. the pair {Mx, My} is only used once in the total possible paired set and the pair {My, Mx} shall not be used). Table 8: Mapping of SIM burst channel index to SIM channels used for SIM mini-burst1 and SIM mini-burst2.

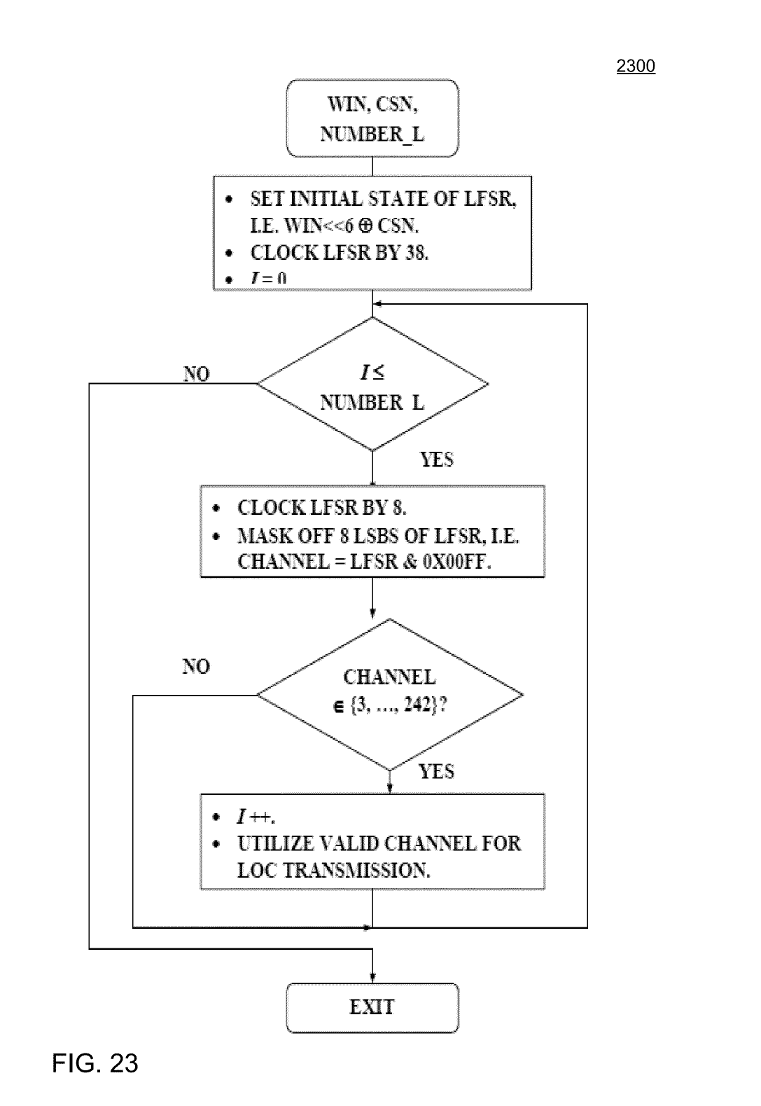

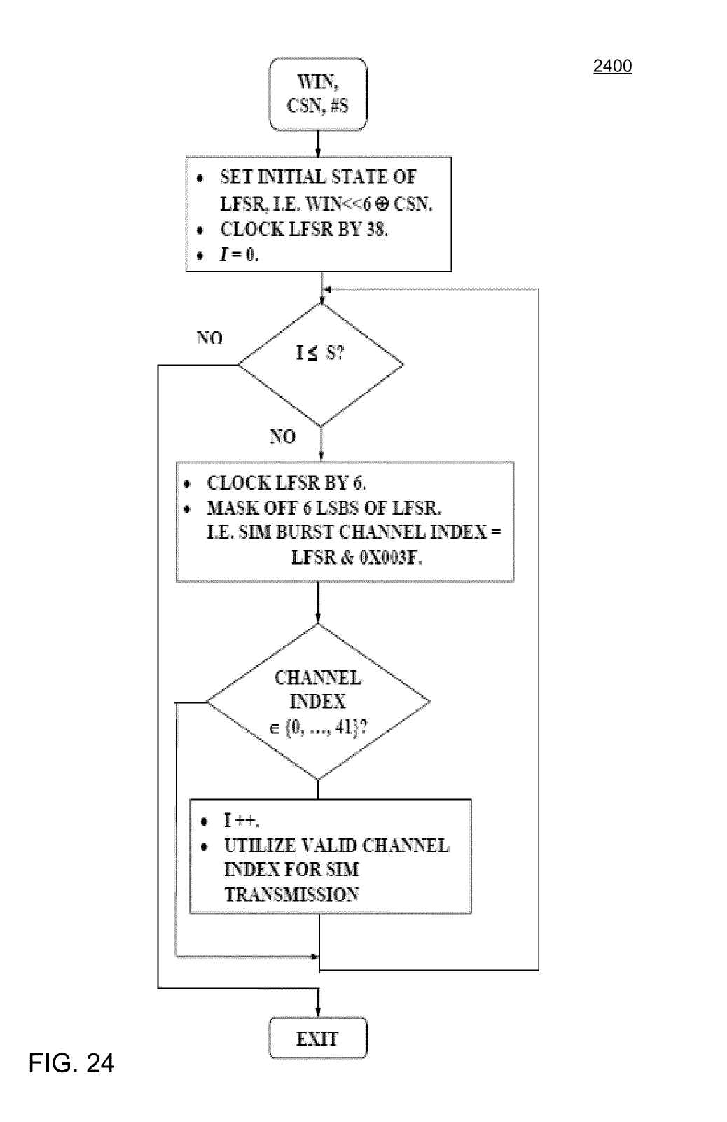

The following tables are used to generate the SIM mini-burst channels from SIM burst channel index obtained by the algorithm given by FIG. 24. There are 42 paired SIM channels. Whenever a SIM burst channel index is generated using the algorithm described by FIG. 23, the corresponding pair of SIM channels are picked up for SIM mini-burst 1 and SIM mini-burst2. If SIM burst channel index is denoted by x, mathematically we can calculate the SIM channels for SIM mini-burst1, i.e. ch₁ and SIM mini-burst2, i.e. ch₂ as follows:

ch₁+Mₓ₊₁,ch₂=Mₓ₊₄₃

where Mᵢ is the ith SIM channel given in Table 5.

| SIM burst | SIM channel | SIM channel |
|---|---|---|
| channel | for SIM | for SIM |
| index (x) | mini-burst, 1 | mini-burst, 2 |
| 0 | M1 | M43 |
| 1 | M2 | M44 |
| 2 | M3 | M45 |
| 3 | M4 | M46 |
| 4 | M5 | M47 |
| 5 | M6 | M48 |
| 6 | M7 | M49 |
| 7 | M8 | M50 |
| 8 | M9 | M51 |
| 9 | M10 | M52 |
| 10 | M11 | M53 |
| 11 | M12 | M54 |
| 12 | M13 | M55 |
| 13 | M14 | M56 |
| 14 | M15 | M57 |
| 15 | M16 | M58 |
| 16 | M17 | M59 |
| 17 | M18 | M60 |
| 18 | M19 | M61 |
| 19 | M20 | M62 |
| 20 | M21 | M63 |
| 21 | M22 | M64 |
| 22 | M23 | M65 |
| 23 | M24 | M66 |
| 24 | M25 | M67 |
| 25 | M26 | M68 |
| 26 | M27 | M69 |
| 27 | M28 | M70 |
| 28 | M29 | M71 |
| 29 | M30 | M72 |
| 30 | M31 | M73 |
| 31 | M32 | M74 |
| 32 | M33 | M75 |
| 33 | M34 | M76 |
| 34 | M35 | M77 |
| 35 | M36 | M78 |
| 36 | M37 | M79 |
| 37 | M38 | M80 |
| 38 | M39 | M81 |
| 39 | M40 | M82 |
| 40 | M41 | M83 |
| 41 | M42 | M84 |

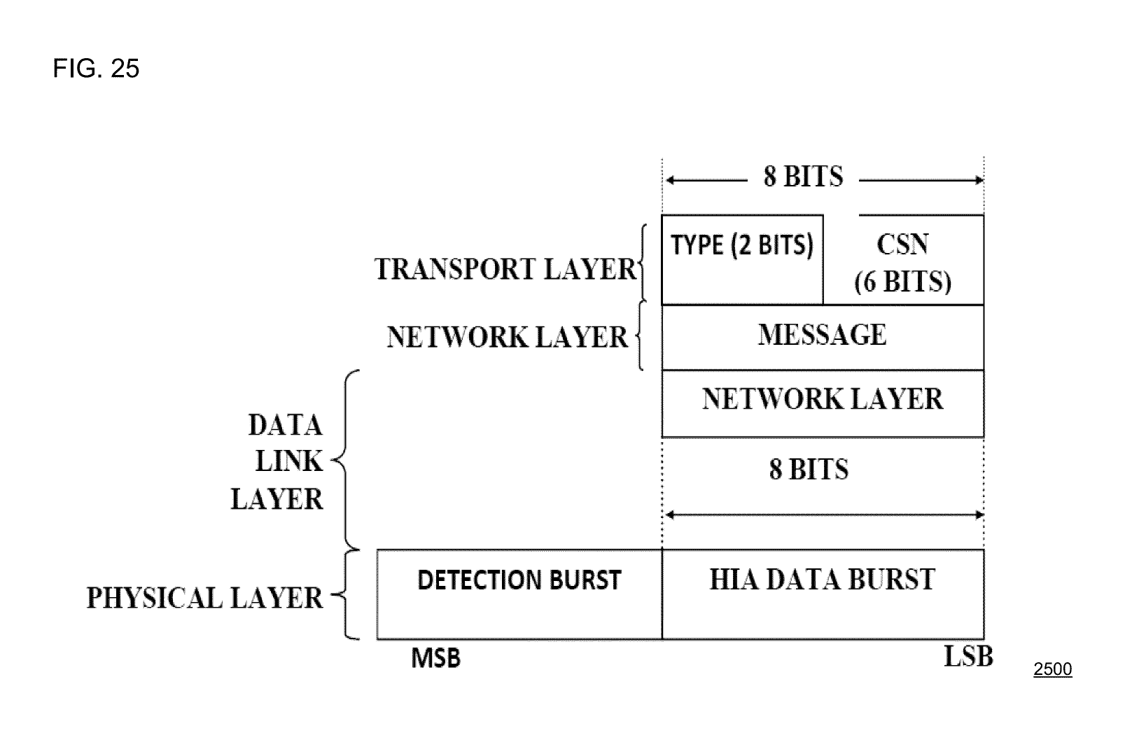

HIA burst protocol stack is shown in FIG. 25.

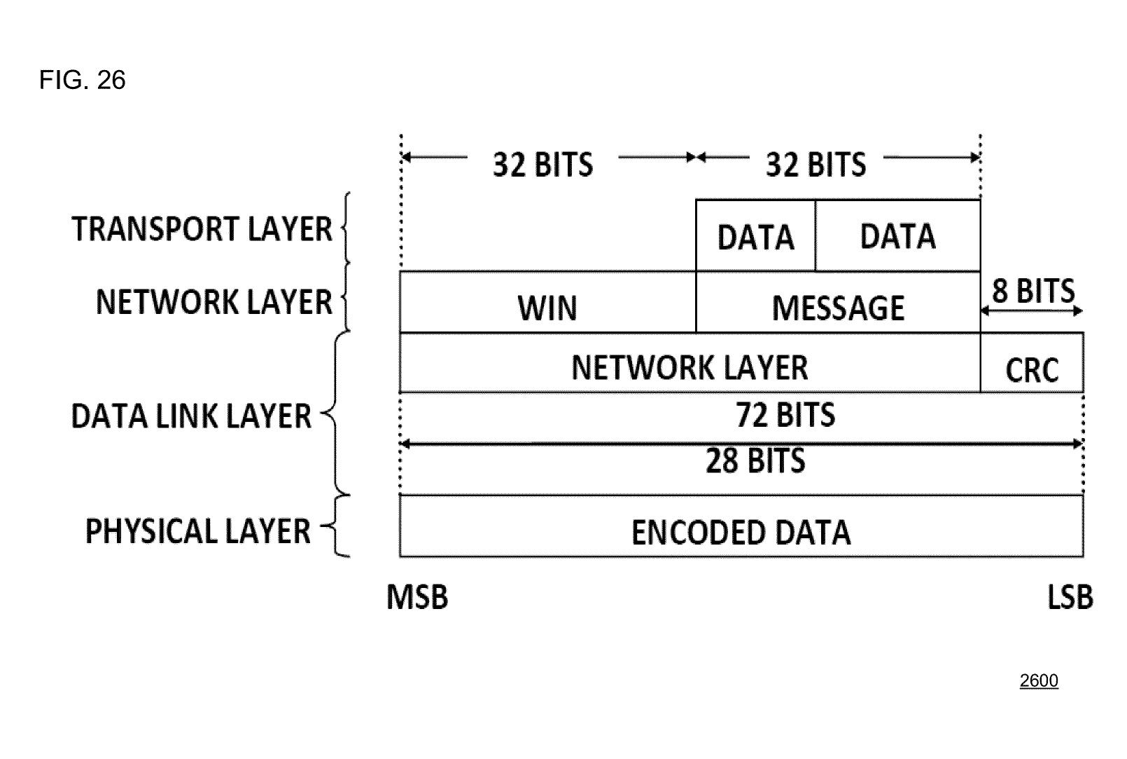

REG mini-burst protocol stack is shown in FIG. 26.

### REG Network Layer

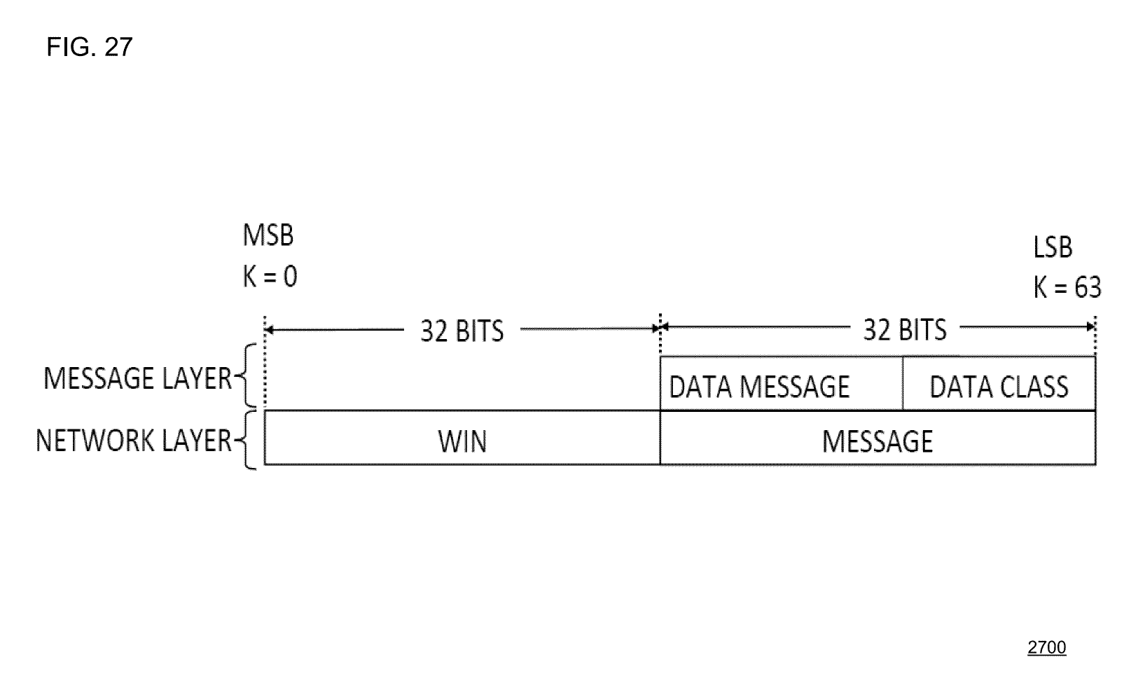

The Network Layer of the REG channel includes of the Message with the addition of the beacon 102 Identification Number. The resulting number of bits from the Network Layer are 64 bits, where MSB are transmitted first, as shown in FIG. 27, where N( ) represents the bits of the Network Layer, W( )) is the WIN bits and:

N(k)=W(k) for k=[0, . . . , 31]

[symbol]

[symbol]

N(k)=M(k−32) for k=[32, . . . , 63]

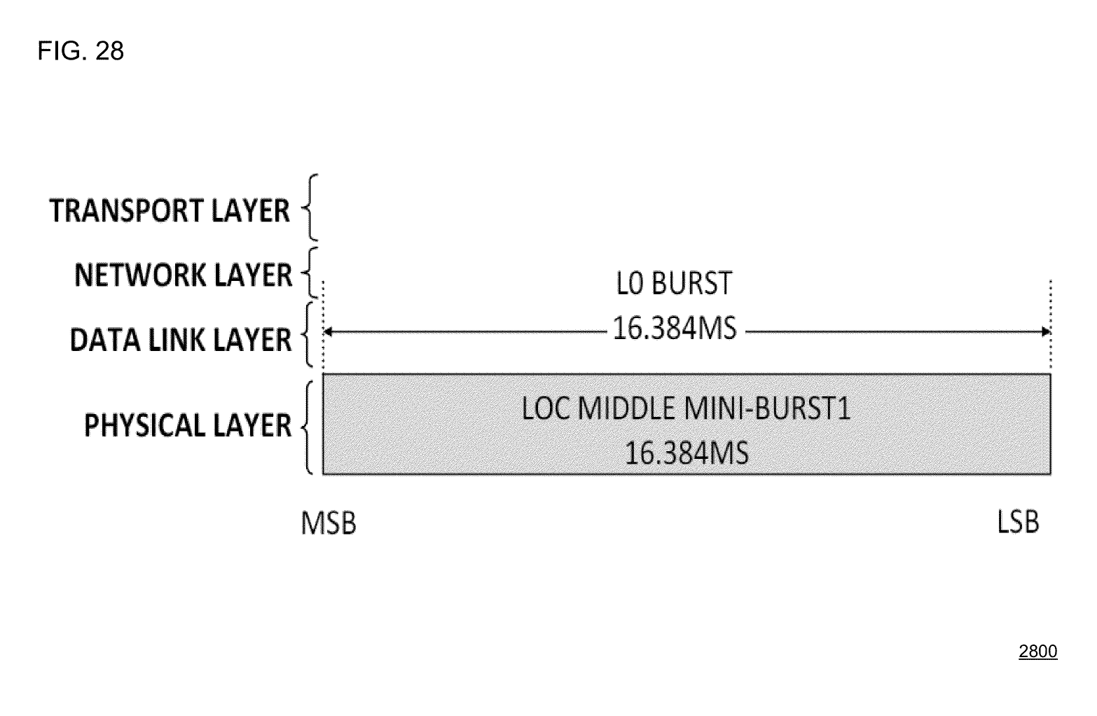

L0 burst protocol stack is shown in FIG. 28.

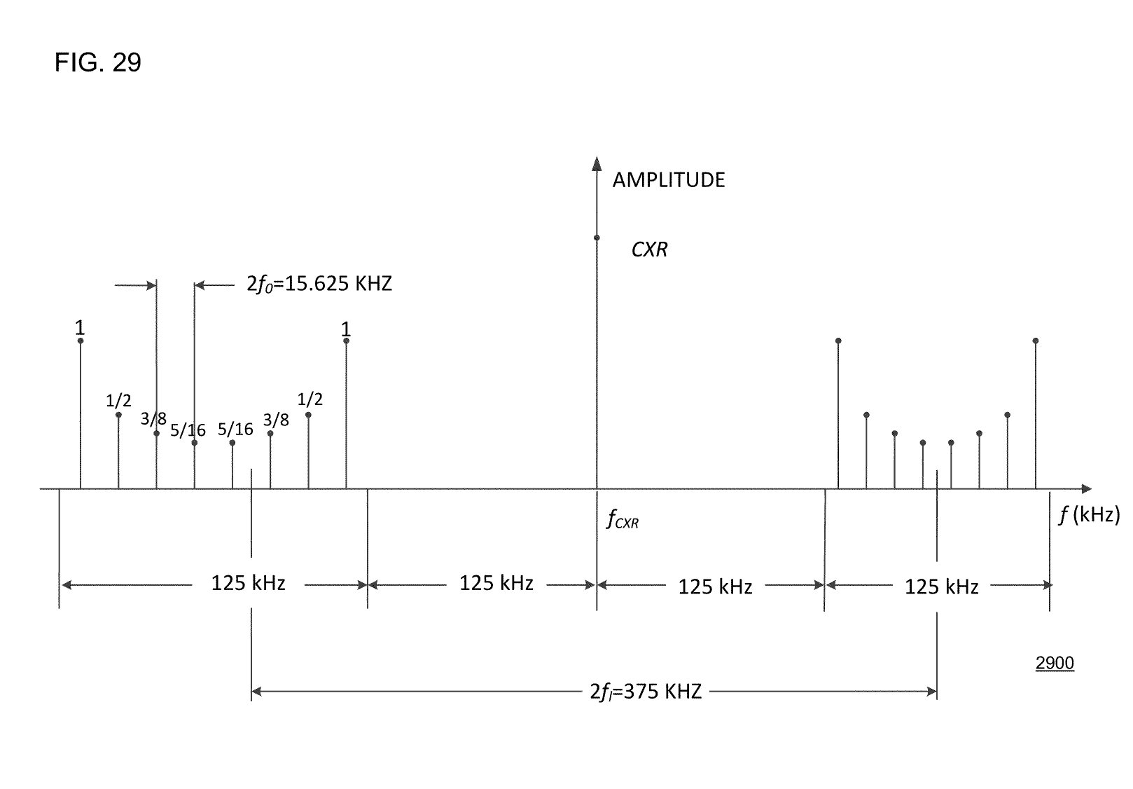

The spectrum of the LOC Middle mini-burst is as shown in FIG. 29.

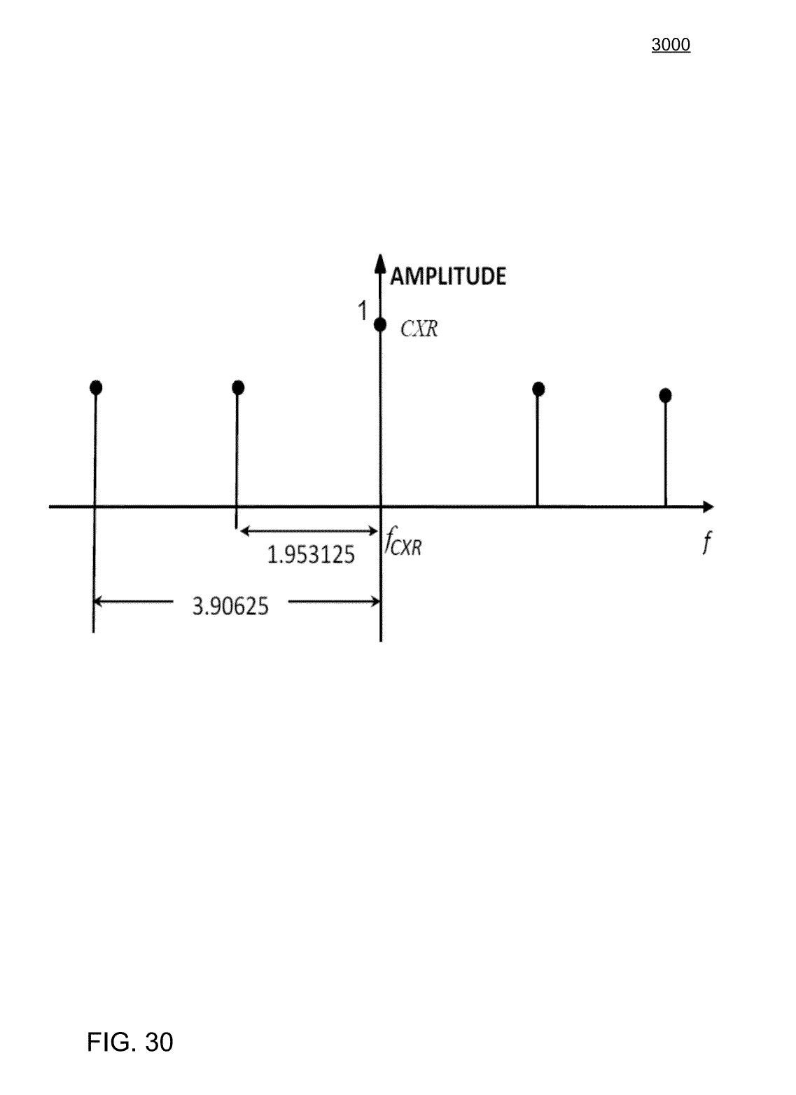

The modulating signal in the ISM 3 LOC Lower mini-burst as shown in FIG. 30 are periodic with 16 periods. One period of the modulating signal may be represented by the following: 864 consecutive binary samples of 0's, 864 consecutive binary samples of 1's, 864 consecutive binary samples of 0's, 864 consecutive binary samples of 1's, 1728 consecutive binary samples of 0's and 1728 consecutive binary samples of 1's. The sampling rate of the digital representation of the modulating signal of the ISM 3 locate waveform is 6750 kbits per second. The entire LOC Lower mini-burst consists of 16 periods (i.e. one LOC Lower mini-burst=16×(864+864+864+864+1728+1728) samples), with duration of 16.384 ms.

LOC Lower mini-burst is shown in FIG. 30

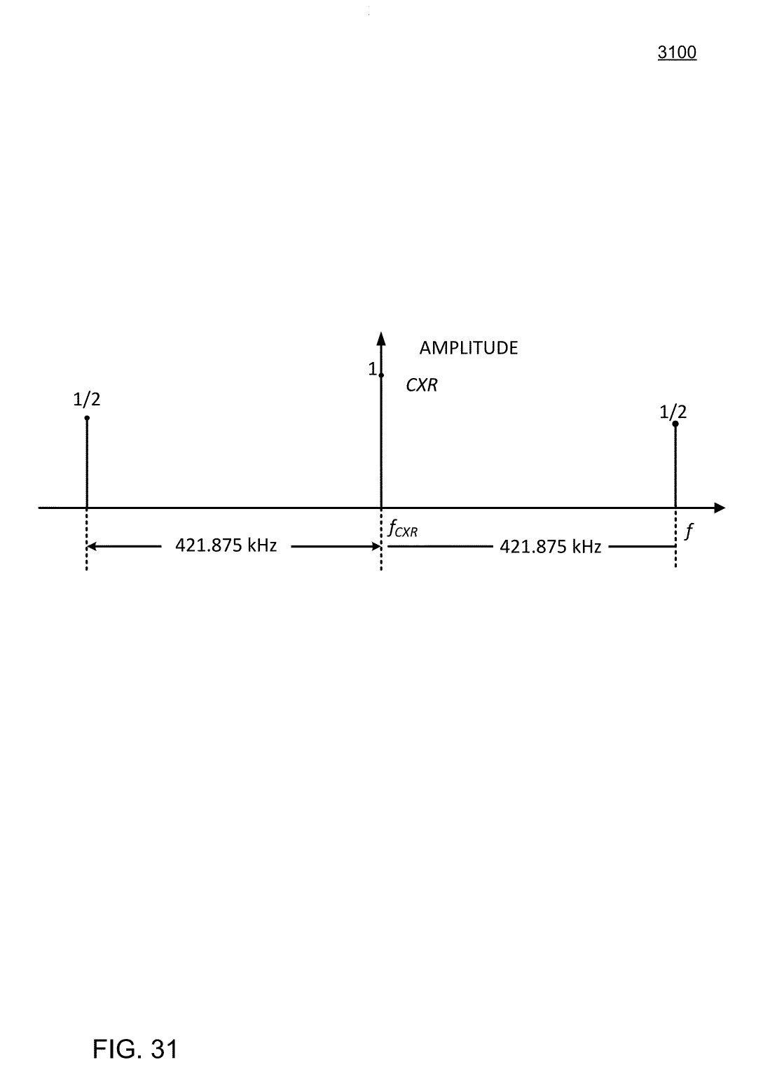

The modulating signal in the LOC Upper mini-burst as shown in FIG. 31 are periodic with 6912 periods. One period of the modulating signal consists of two halves: the first half is represented digitally by 8 consecutive binary samples of 0's. The second half is the complement of the first half, i.e. it consists of 8 consecutive binary samples of 1's. The sampling rate of the digital representation of the modulating signal of the ISM 3 LOC Upper mini-burst is 6750 kbits per second.

A microprocessor may be used to generate the LOC Upper mini-burst as follows: The microprocessor outputs 8 binary samples of 0's followed by 8 binary samples of 1's, which corresponds to one period of the LOC Upper mini-burst (i.e. 1 period=16 binary samples). The entire LOC Upper mini-burst consists of 6912 periods (i.e. one LOC Upper mini-burst=6912×16 samples), with duration of 16.384 ms.

### SIM Protocol Stack

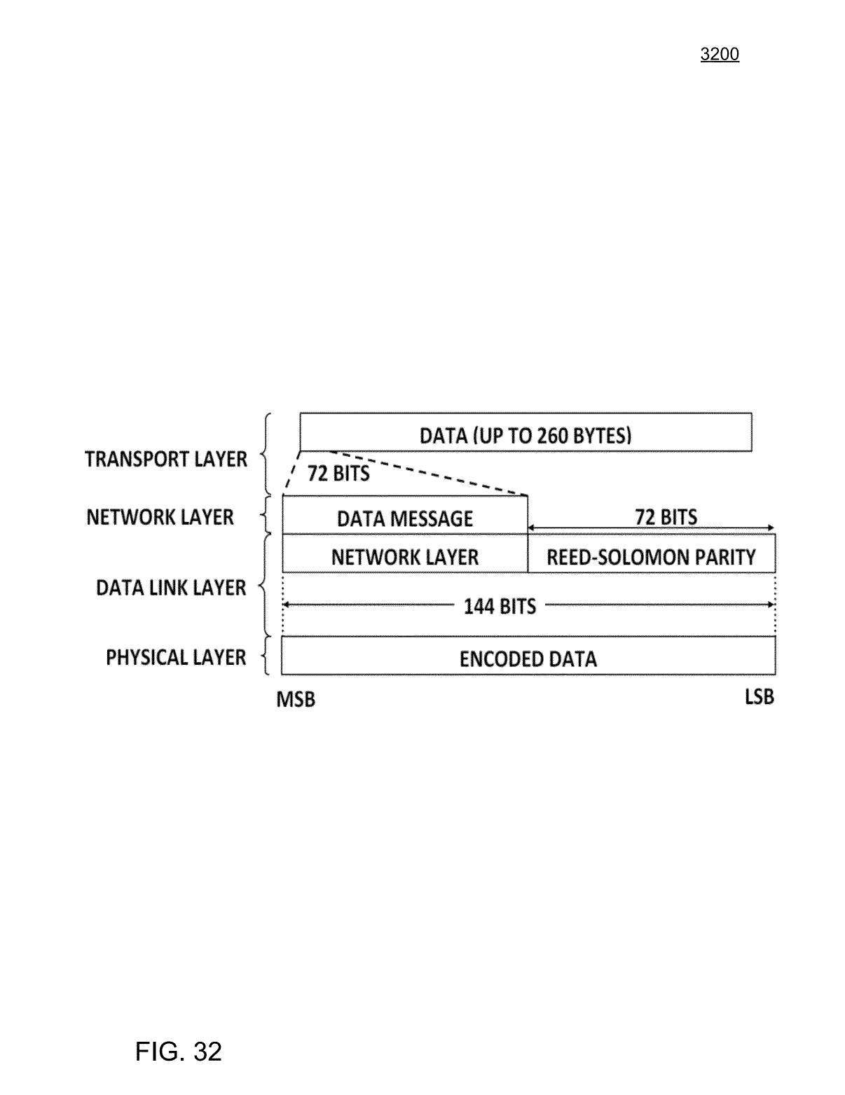

The data are partitioned to 72-bit (9-byte) blocks. If the length of data is not a multiple of 9 bytes, it is required that the beacon 102 shall add some bytes of 0x00 to the end of the data. Each 9-byte block, i.e. 72 bits, are passed to the Data Link Layer for the SIM burst transmission. The Data Link Layer corresponding to the SIM burst shall utilize Reed-Solomon coding that was introduced in the REG mini-burst, to implement enhanced forward error correction capability and reduce the undetected error rate which exists in the current system. The Data link layer for the SIM burst is illustrated in FIG. 32.

### CONCLUSION

A wireless communication system is described. A technical effect of is bifurcated communications from multiple beacons. Although specific implementations have been illustrated and described herein, it will be appreciated by those of ordinary skill in the art that any arrangement which is calculated to achieve the same purpose may be substituted for the specific implementations shown. This application is intended to cover any adaptations or variations. For example, although described in procedural terms, one of ordinary skill in the art will appreciate that implementations can be made in an object-oriented design environment or any other design environment that provides the required relationships.

In particular, one of skill in the art will readily appreciate that the names of the methods and apparatus are not intended to limit implementations. Furthermore, additional methods and apparatus can be added to the components, functions can be rearranged among the components, and new components to correspond to future enhancements and physical devices used in implementations can be introduced without departing from the scope of implementations. One of skill in the art will readily recognize that implementations are applicable to future communication devices, different file systems, and new data types.

1. A computer-accessible medium having processor-executable instructions for wireless communication from a beacon to a network base station receiver, the processor-executable instructions capable of directing a processor to perform:
transmitting a here-i-am (HIA) transmission on a first radio frequency channel of 12 radio frequency channels of a first pseudo-random frequency hopping pattern, the HIA transmission including:
identification of a second radio frequency channel of 42 radio frequency channels;
wherein the HIA transmission is a short transmission that does not include a serial number of the beacon;
transmitting the REG transmission that is synchronized to the HIA transmission on the pseudo-random frequency hopping pattern and in reference to the timing of the pseudo-random frequency hopping pattern, the REG transmission that is synchronized to the HIA transmission including the serial number of the beacon, including the information representative of the one of the plurality of the pseudo-random frequency hopping patterns and including the information representative of the timing of the frequency hopping patterns; and
transmitting a short-and-instant telemetry messaging (SIM) transmission on a third radio frequency channel of the one of the plurality of the pseudo-random frequency hopping patterns and in accordance with the timing of the frequency hopping patterns, the SIM transmission including data, the data including application-specific data including remote meter reading, smart grid, intelligent traffic signs, automotive, road condition telemetry, vending machine reporting, road construction equipment reporting, the data not including the serial number of the beacon and the data not including the information representative of the timing and information representative of the one of the plurality of the pseudo-random frequency hopping patterns,
wherein the 12 radio frequency channels and the 42 radio frequency channels are mutually exclusive and have no radio frequency channels in common between the 12 radio frequency channels and the 42 radio frequency channels.

2. The computer-accessible medium of claim 1, wherein the first radio frequency channel of the 12 radio frequency channels further comprise:
4 radio frequency channels of the 12 radio frequency channels.

3. The computer-accessible medium of claim 1, wherein the first radio frequency channel of the 12 radio frequency channels further comprise:
all 12 radio frequency channels of the 12 radio frequency channels.

4. The computer-accessible medium of claim 1, the medium further comprising processor-executable instructions capable of directing the processor to perform:
attempting receipt of an acknowledgement transmission after the SIM transmission; and
performing the processor-executable instructions of the HIA transmission, the REG transmission that is synchronized to the HIA transmission and the SIM transmission when no acknowledgement transmission is received after a period of time.

5. The computer-accessible medium of claim 1, wherein the pseudo-random frequency hopping pattern further comprises:
a plurality of predefined pseudo-random frequency hopping patterns being stored in a lookup table on a second computer-accessible medium.

6. The computer-accessible medium of claim 1, wherein the information representative of the one of the plurality of the pseudo-random frequency hopping patterns further comprises:
information representative of a process to generate the one of the plurality of the pseudo-random frequency hopping patterns, wherein the process is stored on both the beacon and the network base station receiver.

7. A method of a beacon comprising:
transmitting a here-i-am (HIA) transmission on a first radio frequency channel, to notify a network base station receiver that the beacon is in range of the network base station receiver to access the network base station receiver, to alert to the network base station receiver as to a presence of the beacon and to notify to the network base station receiver of a second radio frequency channel to transmit a registration (REG) transmission synchronized to the HIA transmission;
transmitting the REG transmission that is synchronized to the HIA transmission on the second radio frequency channel, the REG transmission that is synchronized to the HIA transmission including a serial number of the beacon and including information representative of timing and information representative of radio frequencies in a pseudo-random frequency hopping pattern; and
transmitting a short-and-instant telemetry messaging (SIM) transmission on the radio frequencies in the plurality of the pseudo-random frequency hopping patterns and in accordance with the timing, the SIM transmission including data.

8. The method of claim 7, wherein the first radio frequency channel further comprises one of twelve radio frequency channels, the second radio frequency channel further comprises one of forty-two radio frequency channels wherein the twelve radio frequency channels and the forty-two radio frequency channels are mutually exclusive and have no radio frequency channels in common between the twelve radio frequency channels and the forty-two radio frequency channels.

9. The method of claim 7, wherein the data further comprises:
application-specific data including remote meter reading, smart grid, intelligent traffic signs, automotive, road condition telemetry, vending machine reporting, road construction equipment reporting,
the data not including the serial number of the beacon, and
the data not including the information representative of the timing
the data not including information representative of the one of the plurality of the pseudo-random frequency hopping patterns.

10. A computer-accessible medium comprising:
a first component of processor-executable instructions to cause a first transmission from a beacon on a first radio frequency channel, the first transmission providing detection of the beacon by a network base station receiver; and
a second component of processor-executable instructions to cause a second transmission from the beacon on a second radio frequency channel synchronized to the first transmission, the second transmission identifying the beacon and including information that is necessary to grant network access by the network base station receiver to the beacon.

11. The computer-accessible medium of claim 10, wherein the medium further comprises:
a third component of processor-executable instructions to cause a third transmission from the beacon that is synchronized to the second transmission based on the information that is necessary to grant network access, the third transmission including data.

12. The computer-accessible medium of claim 11, wherein the information that is necessary to grant network access further comprises:
radio frequencies in a pseudo-random frequency hopping pattern; and
timing of the frequency hopping patterns.

13. The computer-accessible medium of claim 12, wherein the third transmission from the beacon is transmitted:
on the radio frequencies of the plurality of the pseudo-random frequency hopping patterns; and
in reference to the timing of the frequency hopping patterns.

14. The computer-accessible medium of claim 12, wherein the third component of processor-executable instructions further includes processor-executable instructions to cause the third transmission from the beacon on the first radio frequency channel to include data, the data not including:
a serial number of the beacon;
information representative of the radio frequencies of the pseudo-random frequency hopping pattern; and
information representative of the timing of the frequency hopping patterns.

15. The computer-accessible medium of claim 11, the medium further comprising processor-executable instructions to:
attempt receipt of an acknowledgement transmission after the third transmission; and
perform the processor-executable instructions of the first transmission, the second transmission and the third transmission when no acknowledgement transmission is received after a period of time.

16. The computer-accessible medium of claim 11, the medium further comprising processor-executable instructions to:
perform the processor-executable instructions of the first transmission and the second transmission without processor-executable instructions to wait for an acknowledgement transmission after the processor-executable instructions of the first transmission and the second transmission.

17. The computer-accessible medium of claim 10, wherein the first component of processor-executable instructions further includes processor-executable instructions to cause the first transmission from the beacon on the first radio frequency channel to include:
notice that the beacon is in range of the network base station receiver;
a representation of imminent access to the network base station receiver; and
identification of the second radio frequency channel.

18. The computer-accessible medium of claim 10, wherein the first component of processor-executable instructions does not further include processor-executable instructions to cause the first transmission from the beacon on the first radio frequency channel to include:
a serial number of the beacon;
information representative of radio frequencies of a pseudo-random frequency hopping pattern; and
information representative of timing of the frequency hopping patterns.

19. The computer-accessible medium of claim 10, wherein the second component of processor-executable instructions further includes processor-executable instructions to cause the second transmission from the beacon on the first radio frequency channel to include:
a serial number of the beacon;
information representative of radio frequencies of a pseudo-random frequency hopping pattern; and
information representative of timing of the frequency hopping patterns.

20. The computer-accessible medium of claim 19, wherein the pseudo-random frequency hopping pattern further comprises:
a plurality of predefined pseudo-random frequency hopping patterns being stored in a lookup table on a second computer-accessible medium.

21. The computer-accessible medium of claim 19, wherein the plurality of the pseudo-random frequency hopping patterns further comprises:
information representative of a process to generate the one of the plurality of the pseudo-random frequency hopping patterns, wherein the process is stored on both the computer-accessible medium and the network base station receiver.

22. The computer-accessible medium of claim 10, wherein the first radio frequency channel further comprises a first radio frequency channel selected from a first plurality of radio frequency channels and the second radio frequency channel further comprises a second radio frequency channel selected from a second plurality of radio frequency channels, wherein the first plurality of radio frequency channels is mutually exclusive to the second plurality of radio frequency channels and the first plurality of radio frequency channels is fewer than the second plurality of radio frequency channels.
